(19) United States
(12) Patent Application Publication
(10) Pub. No.: US 2010/0200371 A1
(43) Pub. Date: Aug. 12, 2010

(54) CONVEYOR WITH SELECTIVELY ACTUATED LUGS AND RELATED METHODS

(76) Inventors: Urs Reuteler, Atlanta, GA (US); Charles Ray Landrum, Dunwoody, GA (US); Thomas A. Pool, Atlanta, GA (US); Thomas R. Long, Alpharetta, GA (US)

Correspondence Address: KING & SCHICKLI, PLLC, 247 NORTH BROADWAY, LEXINGTON, KY, 40507, US

(21) Appl. No.: 12/614,898

(22) Filed: Nov. 9, 2009

Related U.S. Application Data
(63) Continuation-in-part of application No. 10/532,528, filed on Oct. 7, 2005.
Application No. 10/532,528 is a continuation-in-part of application No. 11/872,409, filed on Oct. 15, 2007.
(60) Provisional application No. 61/149,793, filed on Feb. 4, 2009.
(60) Provisional application No. 61/112,279, filed on Nov. 7, 2008.
(60) Provisional application No. 60/421,461, filed on Oct. 25, 2002.
(60) Provisional application No. 60/492,161, filed on Aug. 1, 2003.

(51) Int. Cl. B65G 19/02; B65G 19/22

(52) U.S. Cl. 198/730; 198/732

(57) ABSTRACT

A machine for intended use in feeding and completing partially formed cartons is disclosed. In one embodiment, the machine includes a conveyor with selectively actuated lugs that engage and convey the carton. The lugs on each conveyor may be closely spaced or overlapping to allow for selective actuation at a desired instant in time. A diverter located at a transition between the forward and return runs of the lug conveyor may actuates the lugs in a controlled fashion. Related methods of feeding and forming cartons are also disclosed.

This application claims the benefit of U.S. Provisional Patent App. Ser. Nos. 61/149,793 and 61/112,279. This application is a continuation-in-part of U.S. patent application Ser. No. 10/532,528, which is the national stage of international application Ser. No. PCT/US03/34067, and claims the benefit of U.S. Provisional Patent App. Ser. Nos. 60/421,461 and 60/492,161. This application is a continuation-in-part of Ser. No. 11/872,409. The disclosures of all of the foregoing applications are incorporated herein by reference.

### FIELD OF THE INVENTION

The present invention relates to the conveying arts and, more particularly, to a machine for feeding a partially formed and/or filled carton.

### BACKGROUND OF THE INVENTION

Machines for feeding and completing partially formed and/or filled, top-loaded paperboard cartons are well-known in the art. For many years, the most efficient approach for the high speed feeding and forming of such cartons, including closing the lid and sealing the corresponding flaps, was a continuous or in-line one using fixedly mounted, upstanding or “pushers” carried by spaced parallel chains to convey the carton. In past arrangements, the chain length was an exact integer multiple of the flight pitch between the lugs, and the conveyor speed was selected to ensure that the upstanding lugs reach the trailing end of the carton at the desired instant in time. However, the more modern types of “pusher” conveyors include selectively extendable lugs capable of moving from a retracted position to an actuated position for engaging and conveying the carton.

Although the use of extensible lugs solves the timing problems created by fixed lugs, many prior approaches employ lugs attached to the associated chain at fixed intervals generally selected to correspond to the length of the cartons in the conveying direction, and require a chain having a length that is an integer multiple of the flight pitch. This fixed lug-to-lug spacing serves as a significant limitation on the operating speed or throughput of the machine. This is because, unless the actuated lug reaches the trailing end of the carton at the exact instant it is introduced to the machine, a significant delay may occur while this lug catches up (or the next-in-line lug actuated reaches the carton, in the case where the preceding actuated lug has already passed). In relative terms, this resulting delay may be substantial, especially when the length of the carton in the conveying direction only slightly exceeds the fixed pitch distance of the lugs.

Accordingly, a need exists for an improved carton feeding and forming machine for overcoming the foregoing limitations and others. A need is also identified for an improved conveyor with selectively actuated lugs having a variable “pitch,” such that selected lugs may be actuated in different alternating sequences for engaging a series of cartons or other objects, thus making such an arrangement better adapted for use with cartons of varying lengths without altering the linear speed of the conveyor. As will be demonstrated herein, the use of such a conveyor in a carton feeding and forming machine would provide a number of benefits, including but not limited to a vast improvement in efficiency, reliability, and accuracy of the operation with a concomitant reduction in operating and maintenance costs.

### SUMMARY OF THE INVENTION

One aspect of the disclosure relates to a machine for conveying a plurality of partially folded and formed cartons along a conveying path in a conveying direction, each carton having a length in the conveying direction between a leading and a trailing end. The machine comprises a conveyor for conveying a plurality of lugs selectively movable from a non-actuated condition to an actuated condition for engaging the trailing end of the carton and conveying cartons along the conveying path in the conveying direction, with adjacent lugs in at least the non-actuated condition being spaced apart a distance in the conveying direction less than the length of a single carton in the conveying direction. An actuator is provided for actuating a first lug for engaging the trailing end of a first carton and a second lug for engaging the trailing end of a second carton and spaced from the first lug by N lugs in a non-actuated condition, where N is a positive integer greater than one.

In one embodiment, the conveyor comprises a bottom-running conveyor including a stationary support surface for supporting the cartons during conveyance. Preferably, the support surface comprises a passage for the lugs in the actuated condition. A pair of spaced rails may define the passage and provide the desired stationary support for the cartons being conveyed.

The actuator may comprise a diverter, and the actuator may be used to actuate at least every other lug. Preferably, the actuator actuates the first lug spaced apart a distance from the second lug by a length L, wherein L is a linear distance approximately the same as a corresponding dimension of the carton in the conveying direction. Most preferably, the actuator creates a first alternating sequence for actuating every N lugs, followed by and a second alternating sequence for actuating every N±M lugs, where M is a positive integer.

The machine may include a motor for driving a chain carrying the lugs, which motor includes an output signal used to determine actuation of the actuator to move a selected lug to the actuated condition. A controller may also be provided for controlling the motor to drive the chain at a first linear speed during a first lug actuation sequence. The controller may control the motor to drive the chain at substantially the same linear speed during a second lug actuation sequence having a different number of actuated lugs per unit of linear distance in the conveying direction than the first lug actuation sequence. The machine may include a sensor for sensing the lugs in the non-actuated condition and generating an output signal, and the controller may control the motor based on the output signal of the sensor.

In another aspect, an improvement is provided for a conveyor for conveying objects in need of conveyance using a plurality of lugs conveyed by an endless chain and capable of actuation to define a flight pitch of the actuated lugs. The improvement comprises providing the chain with a length that is not an integer multiple of the flight pitch.

In another aspect, this disclosure pertains to a machine for conveying a plurality of partially folded and formed cartons along a conveying path in a conveying direction, each carton having a length in the conveying direction between a leading and a trailing end. The machine comprises a conveyor for conveying a plurality of lugs selectively movable from a non-actuated condition to an actuated condition for engaging the trailing end of the carton and conveying cartons along the conveying path in the conveying direction, with adjacent lugs in at least the non-actuated condition being spaced apart a distance in the conveying direction less than the length of a single carton in the conveying direction. An actuator is provided for actuating every N lugs, where N is a positive integer greater than one. Preferably, the actuator comprises a diverter.

Another aspect of the disclosure relates to a machine for conveying a partially folded and formed carton having an end along a conveying path in a conveying direction. The machine comprises a conveyor for conveying a plurality of lugs arranged in tandem and selectively movable from a non-actuated condition to an actuated condition for engaging the end of the carton and conveying the carton along the conveying path in the conveying direction. A controller is provided for determining the passing of at least two first lugs in a non-actuated condition during conveyance and generating an output signal. An actuator is provided for selectively actuating a second lug following the at least two first lugs based on the output signal from the controller.

In accordance with a further aspect of the disclosure, a method for conveying a partially folded and formed carton having an end along a conveying path in a conveying direction is provided. The method comprises conveying a plurality of lugs selectively movable from a non-actuated condition to an actuated condition for engaging the end of the carton and conveying the carton along the conveying path in the conveying direction. The method further includes the step of determining the passing of a predetermined number of lugs relative to an actuator and generating a signal, and actuating a selected lug based on the signal. The determining step may comprise counting each lug in the non-actuated condition, or determining a position of a motor for conveying the lugs.

Another aspect of this disclosure relates to a method for conveying a plurality of partially folded and formed cartons along a conveying path in a conveying direction. The method comprises conveying an endless chain carrying a plurality of lugs selectively movable from a non-actuated condition to an actuated condition for engaging the carton and conveying the carton along the conveying path in the conveying direction at a first speed. The method includes the step of actuating a plurality of the lugs in a first, alternating sequence, each lug in the actuated condition conveying one of the cartons while conveying the endless chain at substantially the first speed, and actuating a plurality of the lugs in a second, alternating sequence different from the first alternating sequence, each lug in the actuated condition conveying one of the cartons while conveying the endless chain at substantially the first speed. Preferably, the first alternating sequence comprises actuating every N lug, wherein N is a positive integer greater than 1, and the second alternating sequence comprises actuating every N±M lugs, where M is a positive integer.

Another disclosed method is for feeding cartons by providing a plurality of partially folded and formed first cartons for conveyance along a conveying path, said first cartons each having a first dimension in a conveying direction. The method further includes the step of conveying an endless chain carrying a plurality of lugs selectively movable from a non-actuated condition to an actuated condition for engaging the first cartons and conveying the first cartons along the conveying path in the conveying direction at a first speed. The method includes sequentially actuating a plurality of the lugs while conveying the chain at the first speed, each lug in the actuated condition conveying one of the first cartons. The method further includes providing a plurality of partially folded and formed second cartons for conveyance along a conveying path, said second cartons having a second dimension in the conveying direction different from the first dimension. The method further includes actuating a plurality of the lugs while conveying the chain at the first speed, each lug in the actuated condition conveying one of the second cartons.

A further aspect of the disclosure is a method for feeding cartons, comprising: providing a plurality of partially folded and formed first cartons for conveyance along a conveying path having a first dimension in a conveying direction. The method includes conveying an endless chain at a first linear speed, said chain carrying a plurality of lugs selectively movable from a non-actuated condition to an actuated condition for engaging the first cartons and conveying the first cartons along the conveying path in the conveying direction, sequentially actuating a plurality of the lugs, each lug in the actuated condition conveying one of the first cartons, and providing a plurality of partially folded and formed second cartons for conveyance along a conveying path having a second dimension in a conveying direction. The method may include actuating a plurality of the lugs, each lug in the actuated condition conveying one of the second cartons and driving the chain at the first linear speed. The method may further include the step of folding an open lid on one or more of the partially folded and formed first cartons.

### BRIEF DESCRIPTION OF THE DRAWINGS

FIGS. 1a and 1b are overall perspective views of one embodiment of a carton feeding and forming machine;

FIG. 1c is a perspective view of a top-loaded carton with a lid or closure having flaps along three sides thereof;

FIGS. 2a and 2b are partially cutaway front and rear perspective views of the infeed conveyor forming part of the machine of FIGS. 1a and 1b;

FIG. 3a is a side elevational view of an individual lug conveyor forming part of an intermediate conveyor in the machine of FIGS. 1a and 1b;

FIG. 3b is a front perspective view of the lug conveyor of FIG. 3a;

FIG. 4a is a bottom perspective view of a chain with closely spaced pivoting lugs for possible use in the lug conveyor of FIGS. 3a and 3b;

FIG. 4b is a partially cross-sectional, partially cutaway view illustrating the manner in which a selected lug may be actuated in the lug conveyor of FIGS. 3a and 3b;

FIG. 4c is a partially cutaway, schematic side view showing the progressive actuation of a single lug selected for actuation;

FIG. 4d is a partially exploded, partially cutaway perspective view of the lug conveyor of FIGS. 3a and 3b;

FIG. 4e is a perspective view of the lug conveyor of FIG. 4d in an assembled state;

FIG. 5a is a partial end elevational view of the machine of FIGS. 1a and 1b, taken from the infeed end;

FIG. 5b is a partially cutaway, rear perspective view of the infeed end of the machine showing one example of a rotatable wheel for pre-folding a flap on the carton as it advances through the machine;

FIG. 5c is a perspective view of the pre-folding wheel apart from the machine and the mechanism for causing the wheel to selectively rotate;

FIG. 6a is a partially cutaway side view of the machine taken from the rear, illustrating in particular the infeed end and the location of the pre-folding wheel relative to the front overhead lug conveyor;

FIGS. 6b-6e illustrate the progressive and combined operation of the pre-folding wheel and lug conveyor for folding a trailing end flap on a carton while it is conveyed through the machine;

FIG. 7 is a partially cutaway perspective view of the structures or means for folding a flap positioned along the intermediate conveyor and adjacent to the conveying path defined thereby;

FIG. 8 is a partially cutaway, schematic side view illustrating the manner in which the actuated depending lugs are withdrawn at the discharge end of the intermediate conveyor;

FIG. 9 is a perspective view of a takeaway conveyor associated with the discharge end of the intermediate conveyor;

FIG. 10 is a side elevational view of the takeaway conveyor that also provides an end view of the intermediate conveyor;

FIG. 11 is partially schematic side view illustrating the manner in which the lugs of the takeaway conveyor are selectively actuated to the upstanding position for engaging and conveying the partially formed carton while the remaining flaps are folded and sealed;

FIG. 12 is a top view of the machine showing the infeed conveyor and the positioning of the intermediate and takeaway conveyors generally perpendicular to one another;

FIG. 13 is a block diagram showing the interrelationship between the controller for the machine and the various components thereof; and

FIGS. 14-20 illustrate further embodiments of conveyors for feeding partially formed cartons.

### DESCRIPTION OF THE INVENTION

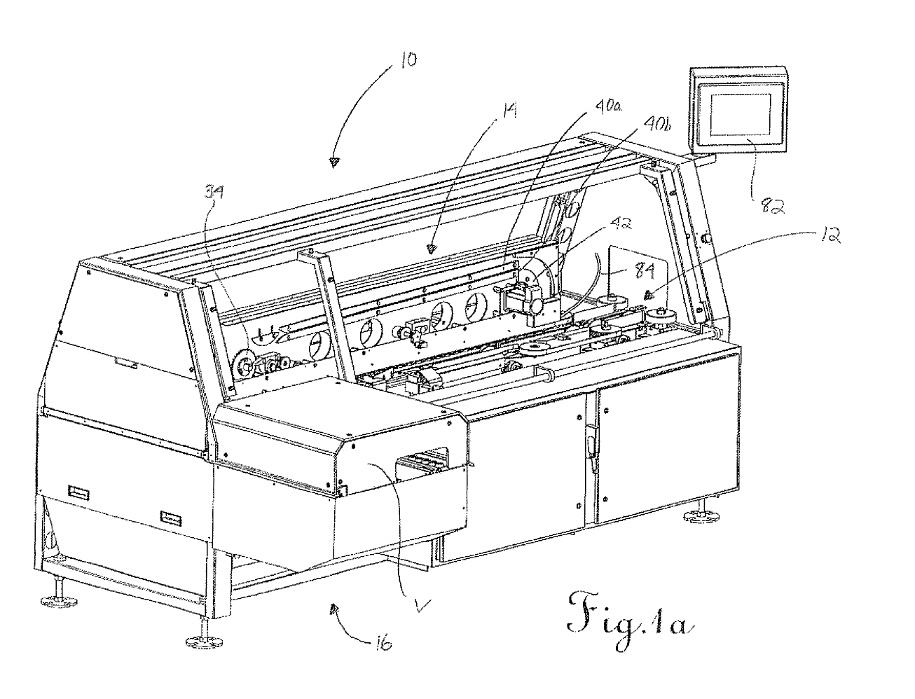

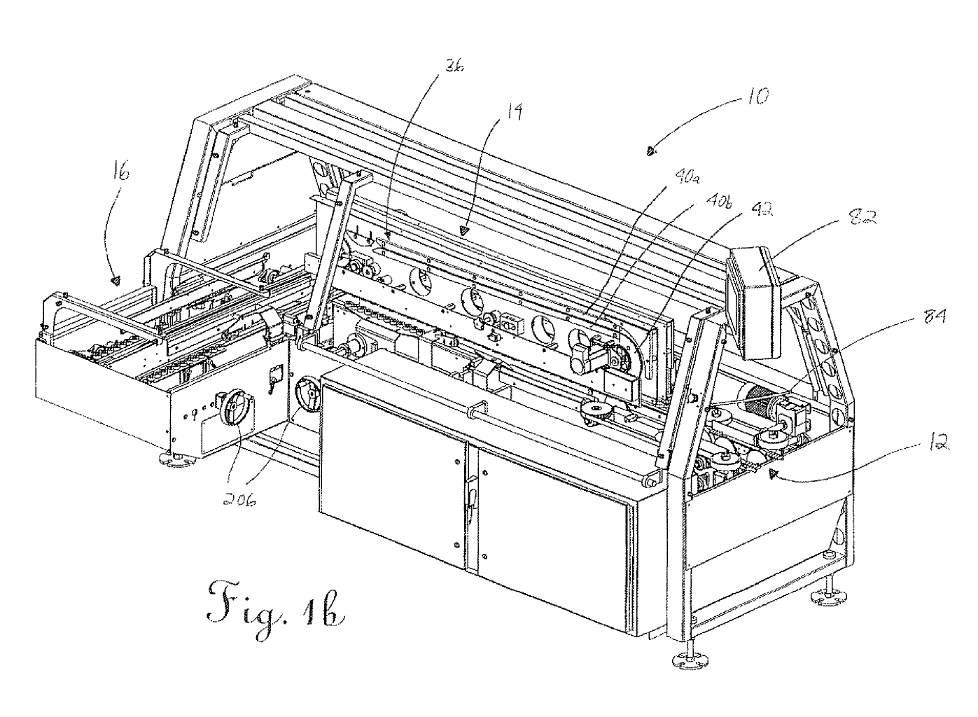

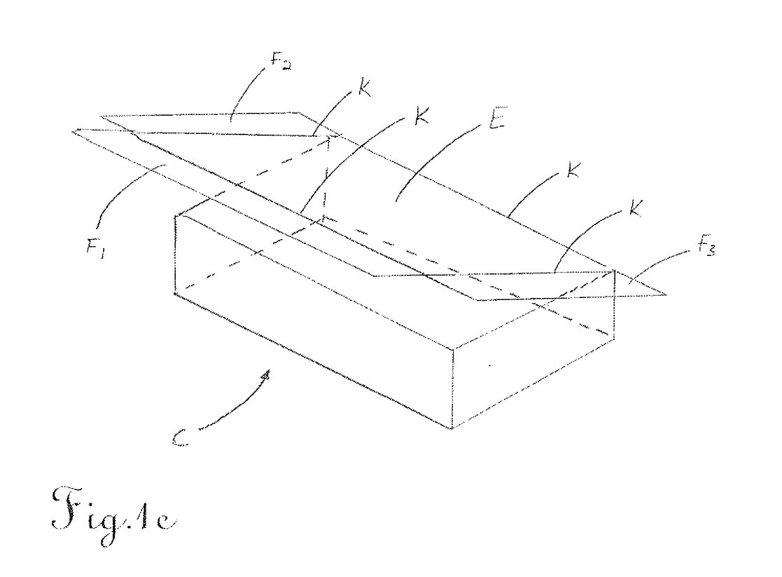

Reference is now made to FIGS. 1a and 1b showing an overall perspective view of one embodiment of a carton conveying machine 10. In the illustrated embodiment, the machine 10 includes an in-line infeed conveyor 12 and a takeaway conveyor 16 (which is partially obscured by an optional cover V in FIG. 1a). In one embodiment of the disclosure, an overhead conveyor 14 is positioned intermediate the two conveyors 12, 16. In this embodiment, the three conveyors 12, 14, 16 together define a substantially horizontal conveying or flow path for objects being conveyed.

As will be recognized by those of skill in the art, the machine 10 of the present invention is particularly useful in a cartoning line for top-loaded style of cartons C with a lid E or closure having a front flap F₁ and generally opposed side flaps F₂, F₃ (see FIG. 1c) with hinges defined by score or fold lines K. A carton C of this type may be formed from a blank by an upstream forming apparatus (not shown, but see for example commonly assigned U.S. Pat. No. 5,177,930 to Harston et al., the disclosure of which is incorporated herein by reference). In the typical arrangement, the carton with the lid E is an open position is filled with product while traveling between the forming apparatus and the infeed conveyor 12 of the machine 10.

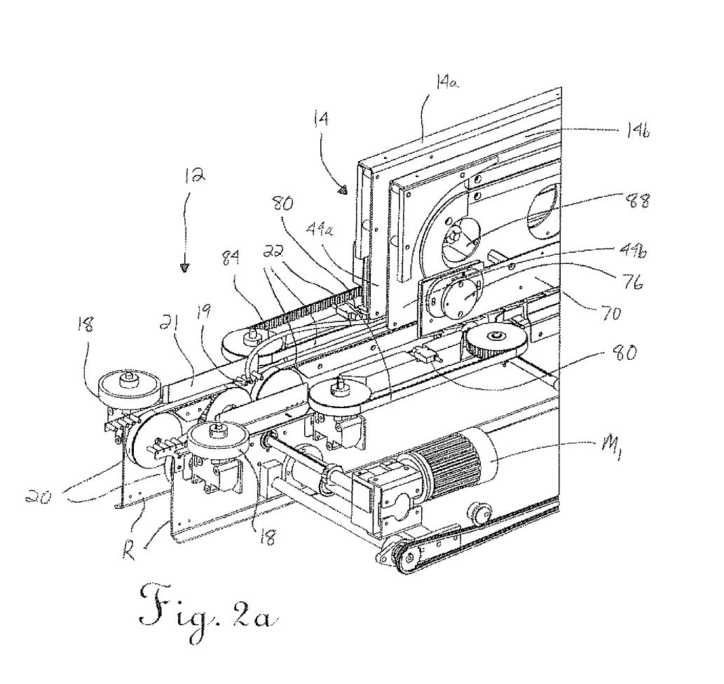

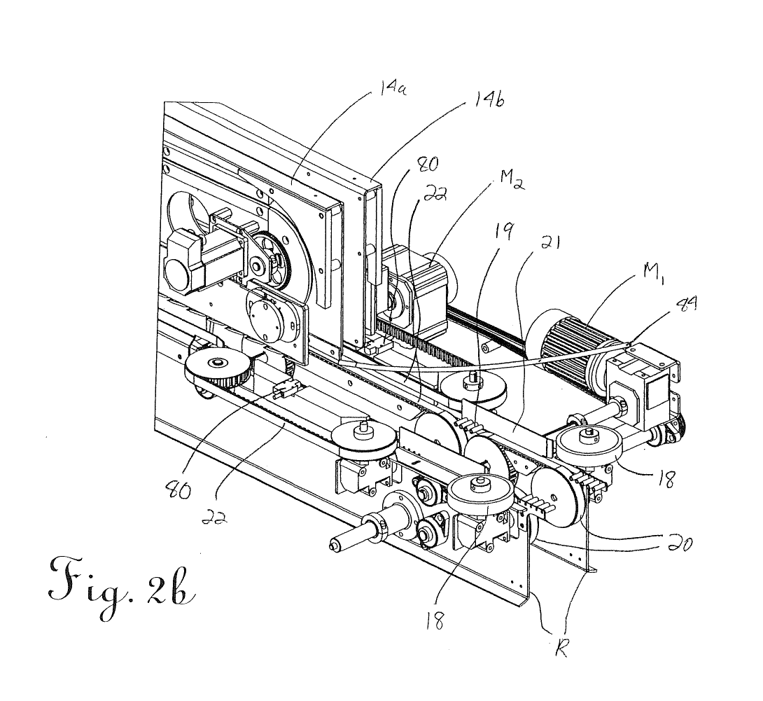

As perhaps best shown in FIGS. 2a and 2b, the infeed conveyor 12 in the illustrated embodiment includes metering devices in the form of a pair of spaced “hold back” wheels 18. These wheels 18 are supported by first and second spaced frame members R of the machine 10, and serve to initially receive and engage the corresponding sides of the carton while adjacent endless belt conveyors 20 frictionally engage the carton and urge it forward. This combination of wheels 18 and belt conveyors 20 ultimately deliver the individual cartons in a serial fashion at spaced intervals over idler rollers 19 and through spaced parallel guides 21 to corresponding pairs of spaced, generally parallel infeed belt conveyors 22 for frictionally engaging the sides and bottom of the carton to deliver it to the intermediate conveyor 14.

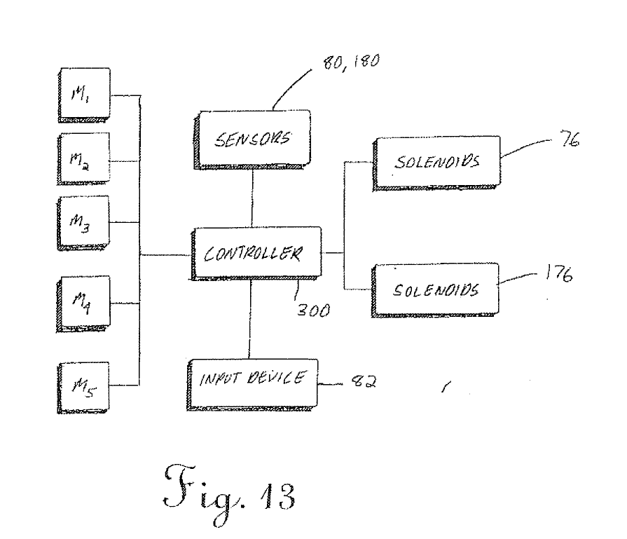

In one anticipated arrangement, the feed of partially formed and filled cartons to the machine 10 is random, and the belt conveyors 20, 22 are adapted to accelerate the randomly received cartons such that each travels at a known, substantially constant speed upon encountering the intermediate conveyor 14. The first set of belt conveyors 20 may be driven by a first motor M₁ (which may be a servomotor or variably frequency drive, and may also drive the metering wheels 18 at the same speed) and the second set of belt conveyors 22 may be independently driven by a second motor M₂. The use of independent first and second motors M₁, M₂ of course allows for driving the sets of belt conveyors 20, 22 at different speeds, as desired for a particular throughput or mode of operation. As outlined further in the description that follows, the speed control of the various motors and other aspects of the machine may be effected by an onboard computer or like logic device serving as a controller (see FIG. 13).

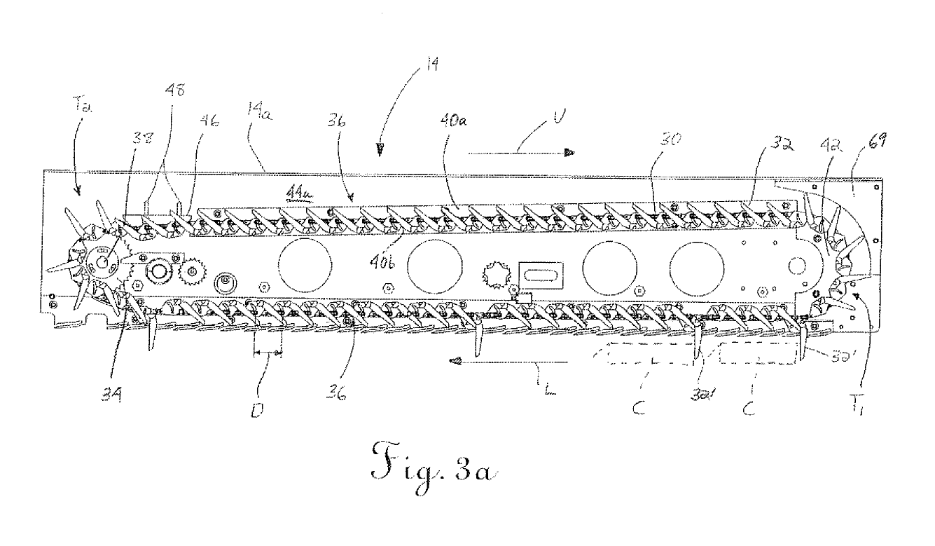

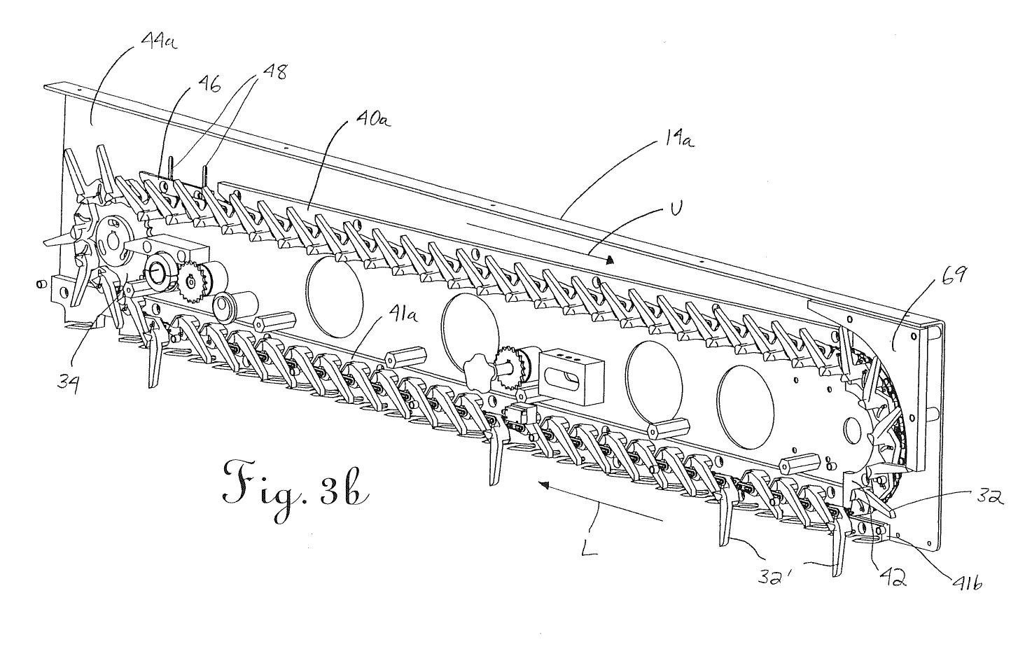

With reference to FIGS. 2b and 3a-3b, the construction of the intermediate conveyor 14 that receives the cartons from the infeed conveyor 12 and conveys them along a horizontal path in a first direction is now described in detail. In the illustrated embodiment, the intermediate conveyor 14 is comprised of a pair of spaced, generally parallel lug conveyors 14a, 14b (front and rear when the machine 10 is in the orientation shown in FIG. 1a) that overlie and define a conveying path. As perhaps best shown in FIG. 3a, each lug conveyor 14a, 14b includes a chain 30 driven in an endless path along a forward or lower run (action arrow L) and a return or upper run (action arrow U), with first and second transitions T₁, T₂ between the runs. Each chain 30 carries a plurality of extensible lugs 32 that, as described in more detail below, may be selectively actuated from a retracted or normal position to a depending (or “pop-down”) actuated position at a desired instant in time for engaging and conveying the partially folded and formed cartons received from the infeed conveyor 12.

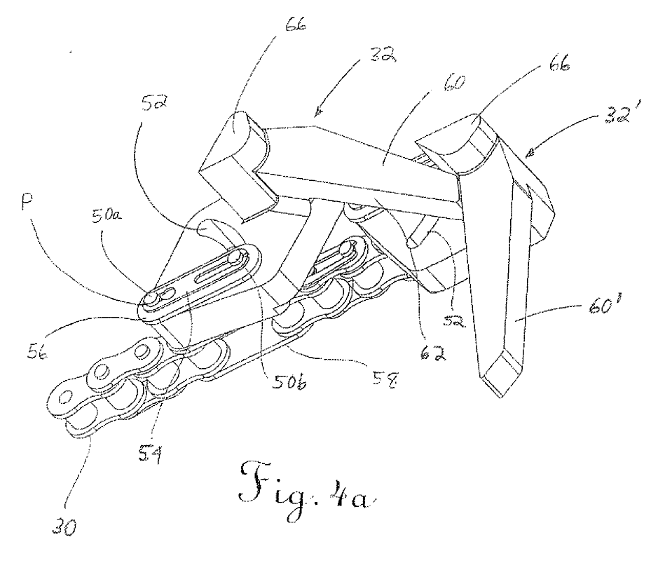

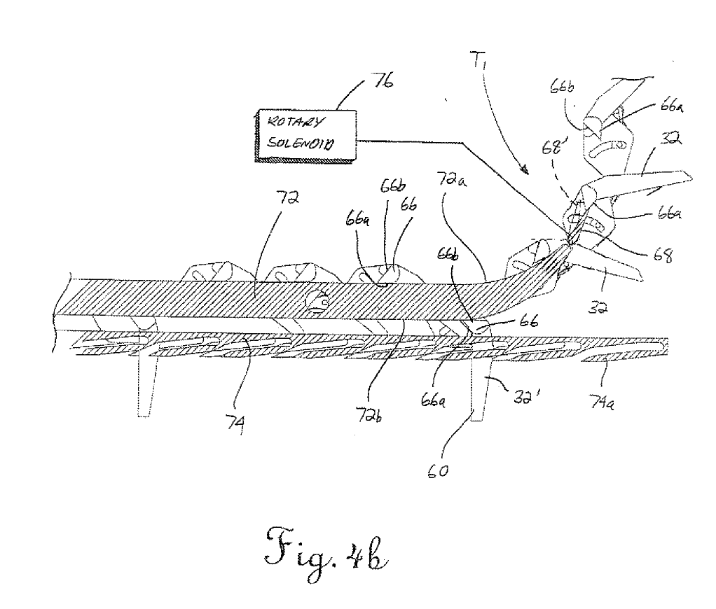

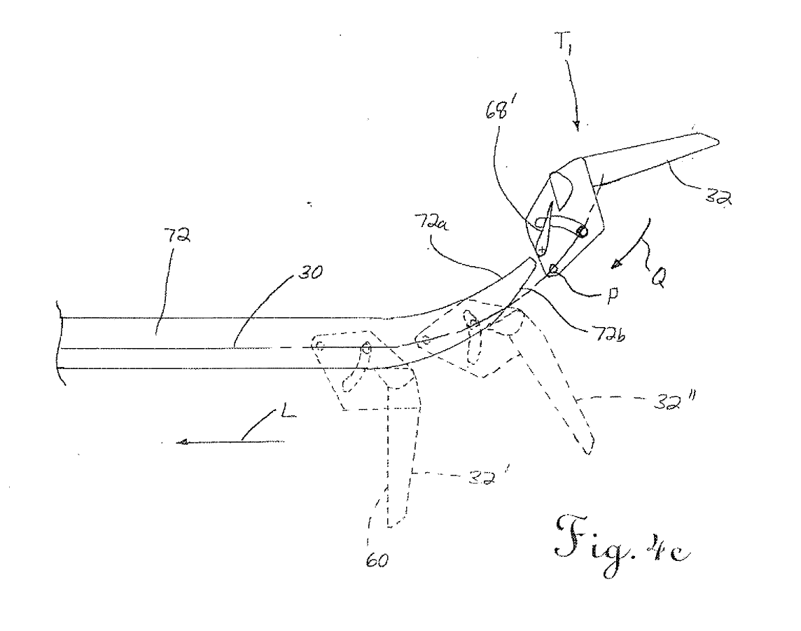

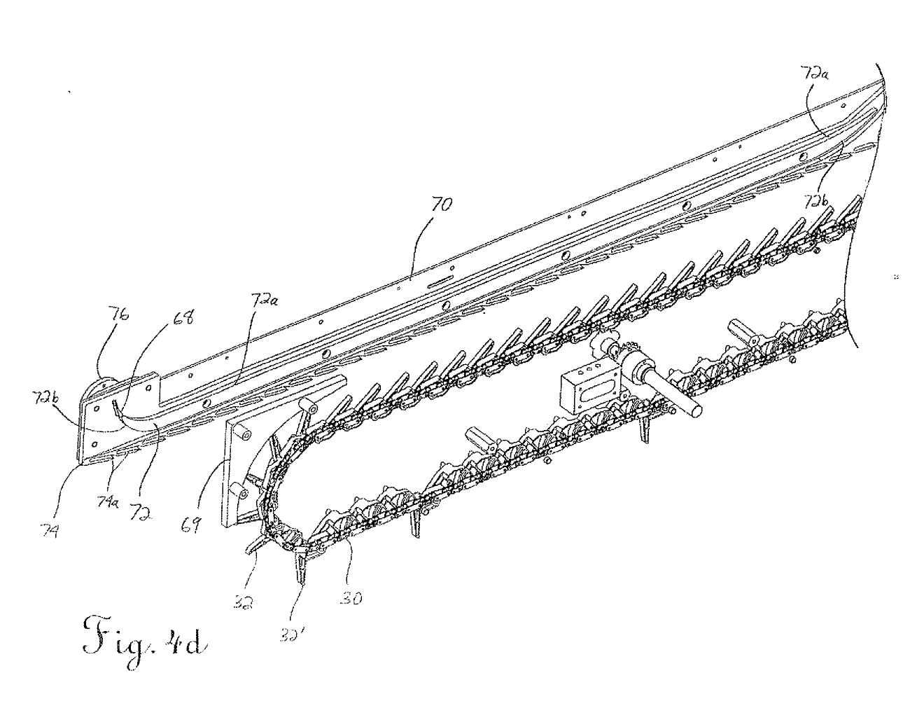

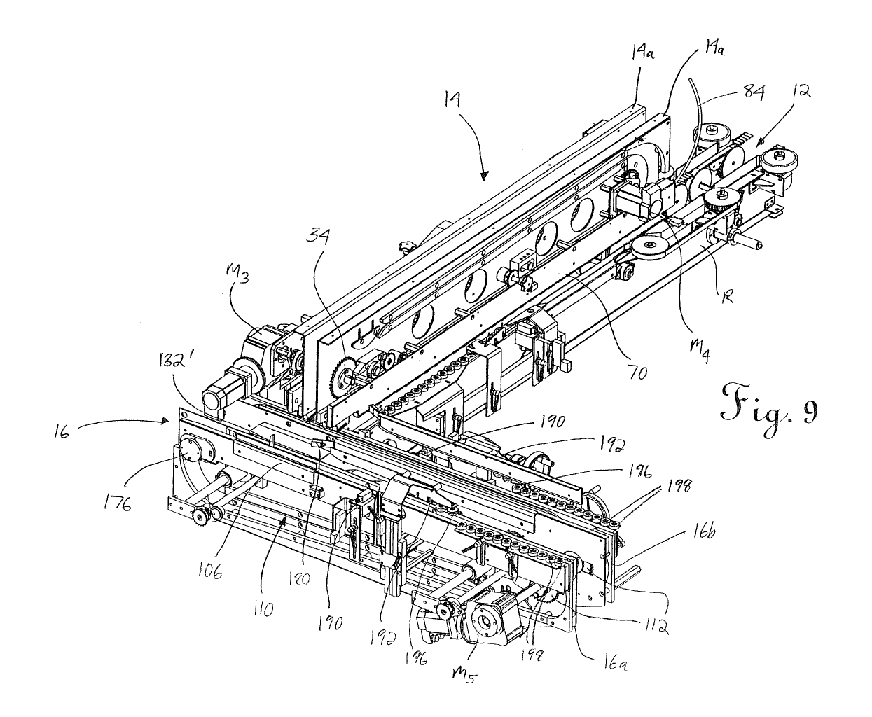

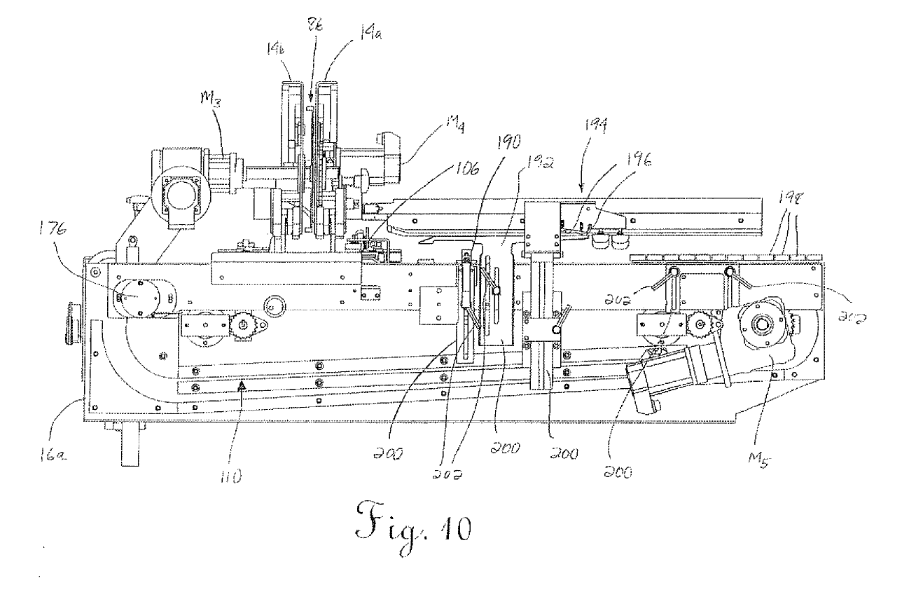

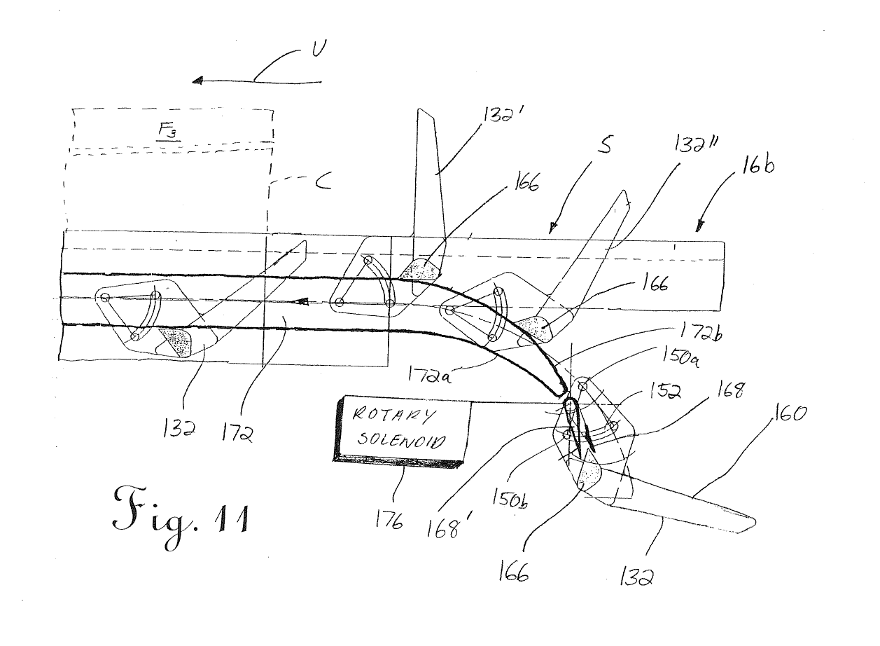

More specifically describing the lug conveyors 14a, 14b, each includes a drive sprocket 34 for engaging and driving the corresponding chain 30 along an endless path defined by a guide track 36. Preferably, the sprocket 34 of each lug conveyor 14a, 14b is mounted on a common shaft 38 and gang-driven by a common motive device or third motor M₃ (see FIGS. 9 and 10). Consequently, each chain 30 is moved along the endless path at substantially the same speed. The chains 30 may be conventional link chains (see FIG. 4a), which may include friction-reducing rollers.

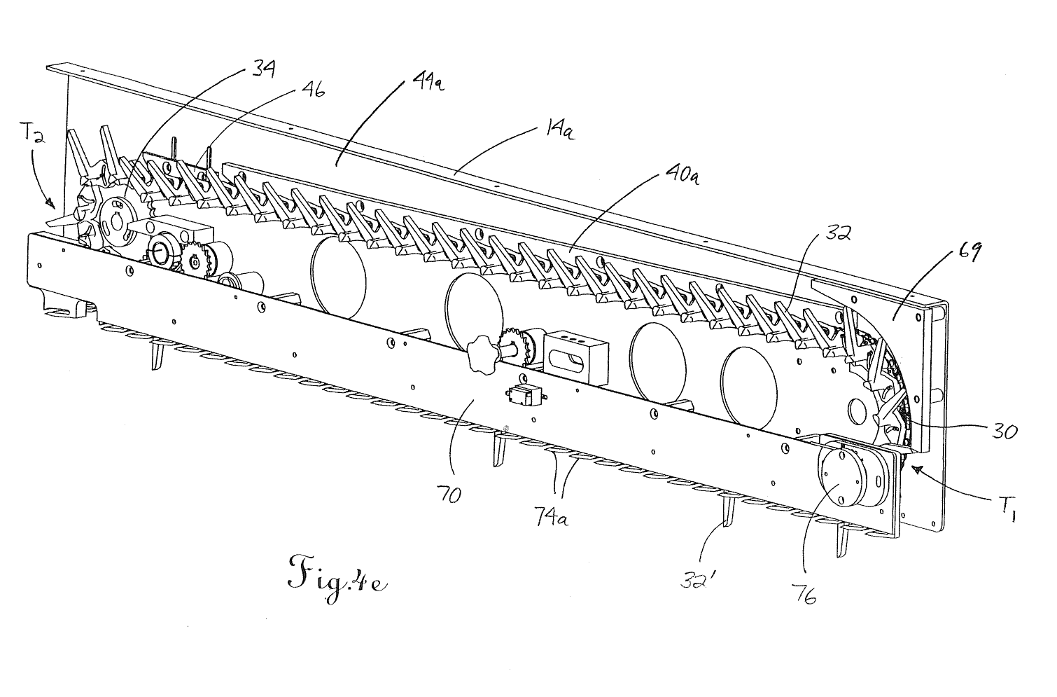

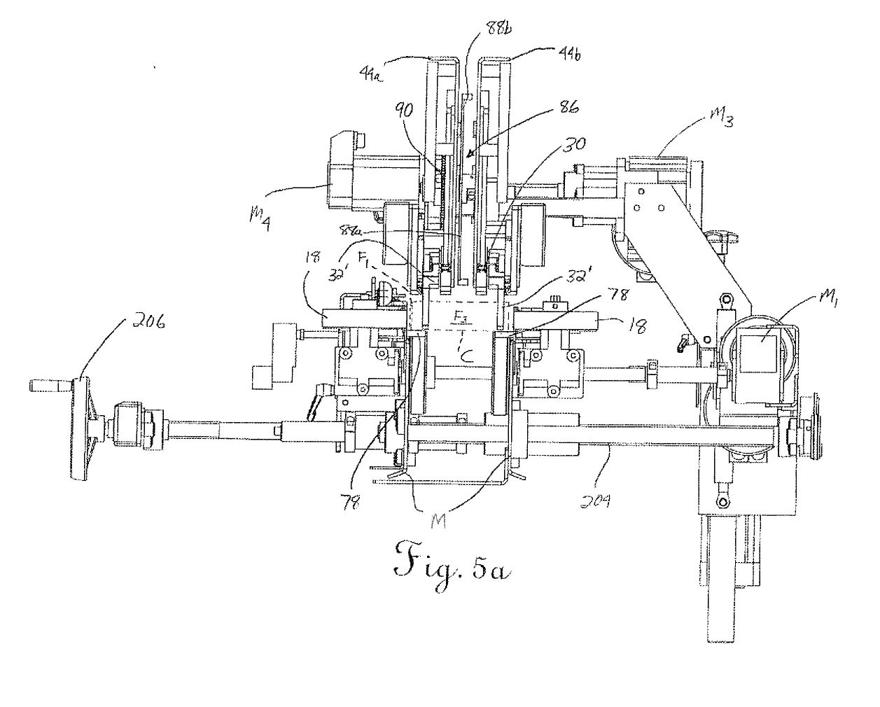

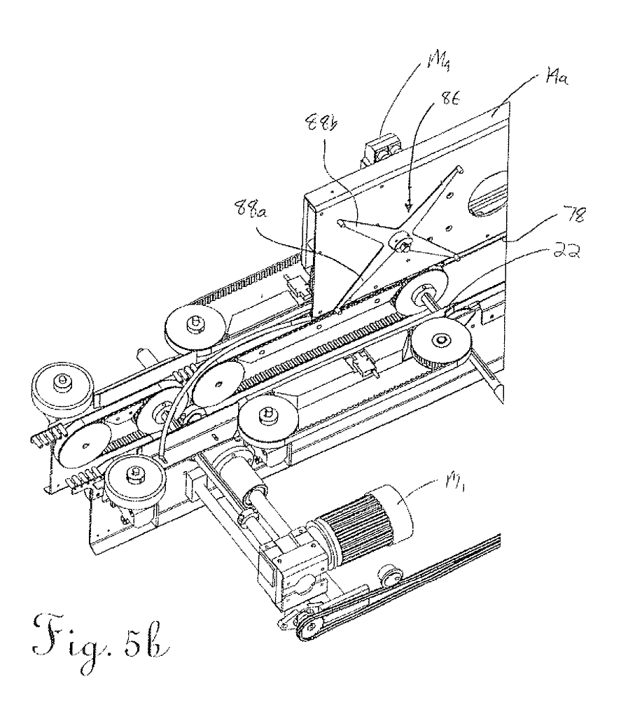

As perhaps best shown in FIGS. 1a and 1b, the guide track 36 along the return or upper run U comprises a pair of elongated, spaced chain guides 40a, 40b creating a channel adapted for receiving the chain 30. To transition the chain 30 from the return, upper run U to the forward, lower run L, an end guide 42 with an outwardly directed rounded or semi-circular engagement face is positioned for guiding the chain 30 along the corresponding transition T₁. Similar elongated spaced chain guides 41a, 41b (see FIG. 3b) form a channel for receiving and guiding the chain 30 along the forward or lower run L, which also comprise part of the guide track 36. The chain guides 40a, 40b; 41a, 41b; 42 may be supported by a frame member 44a, 44b associated with each conveyor 14a, 14b (see FIG. 5b).

To ensure that the chains 30 are maintained in a substantially taut condition, an adjustable tensioner may also be associated with each lug conveyor 14a, 14b. In the embodiment illustrated in FIGS. 3a and 3b, the tensioner is in the form of a cam 46 having a rounded or semi-circular face for engaging a surface of the chain C as it moves from engagement with the sprocket 34 toward the upper chain guides 40a, 40b forming part of the guide track 36. Fasteners (not shown) passing through vertically-oriented slots 48 formed in the frame members 44a, 44b allow for the relative position of the cam 46 to be easily adjusted to vary the tension on the corresponding chain 30.

With reference now to FIGS. 4a-4e, the manner in which selected lugs 32 associated with the chains 30 of the conveyors 14a, 14b (or conveyor 16, as outlined in the discussion that follows) are simultaneously pivoted or moved to the actuated or depending position for engaging and conveying an object, such as a carton, is now described in detail. Turning first to the bottom perspective view of FIG. 4a, each lug 32 is mounted to and carried by the chain 30 such that it is capable of pivoting movement. For example, a pair of pins 50a, 50b may extend transversely from the chain 30 at selected intervals. A first one of the pins 50a passes through a hole (not shown) formed at one end of the lug 32 and the second pin 50b passes through a generally arcuate slot 52 formed in the body of the lug 32. A removable locking retainer 54 holds a plate-like bearing 56 against the outer surface of the lug 32, and a corresponding elongated connector 58 is provided for interconnecting the links (not numbered) along the opposite side of the chain 30.

As a result of this arrangement of structures, each lug 32 may freely pivot or rotate about the pivot point P (clockwise in the view of FIG. 4c; note action arrow Q) defined by the first pin 50a and travel along an arcuate path defined by the slot 52. Thus, a point on the surface of the lug 32 during pivoting is considered to follow an arcuate path. Preferably, when the lug 32 is in the retracted or “laid-back” position, as is the leading lug in FIG. 4a, the pin 50a is moved to the lower end of the slot 52. In this position, a projecting pusher 60 of the lug 32 remains withdrawn from the adjacent path of conveyance (see FIGS. 3a and 3b) and thus forms an acute angle with the horizontal plane. In contrast, when the lug 32 is in the actuated or depending position, like the trailing lug 32′ in FIG. 4a, the second pin 50b is moved to the opposite or upper end of the slot 52. Consequently, the pusher 60 extends into the conveying path for engaging the carton, and is generally perpendicular to the horizontal plane.

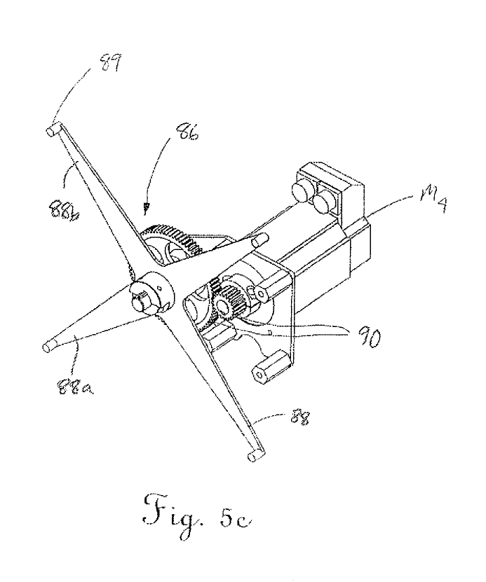

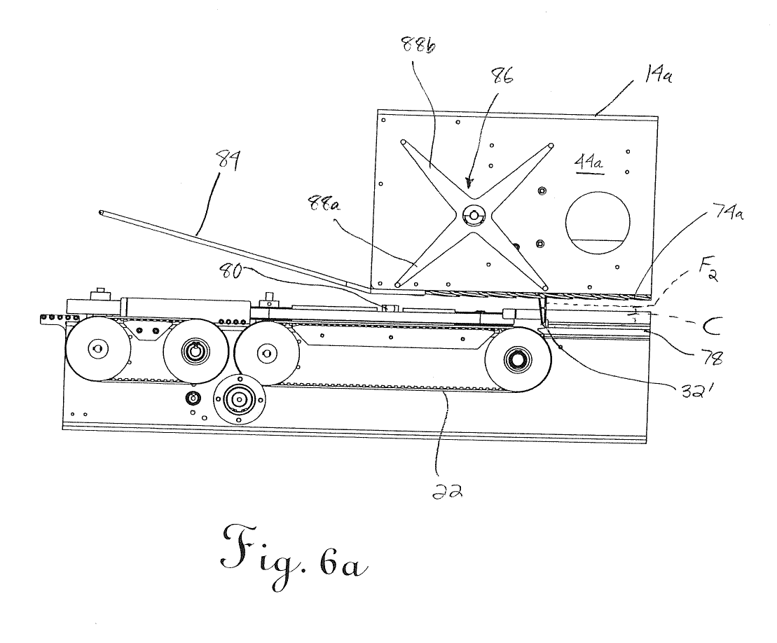

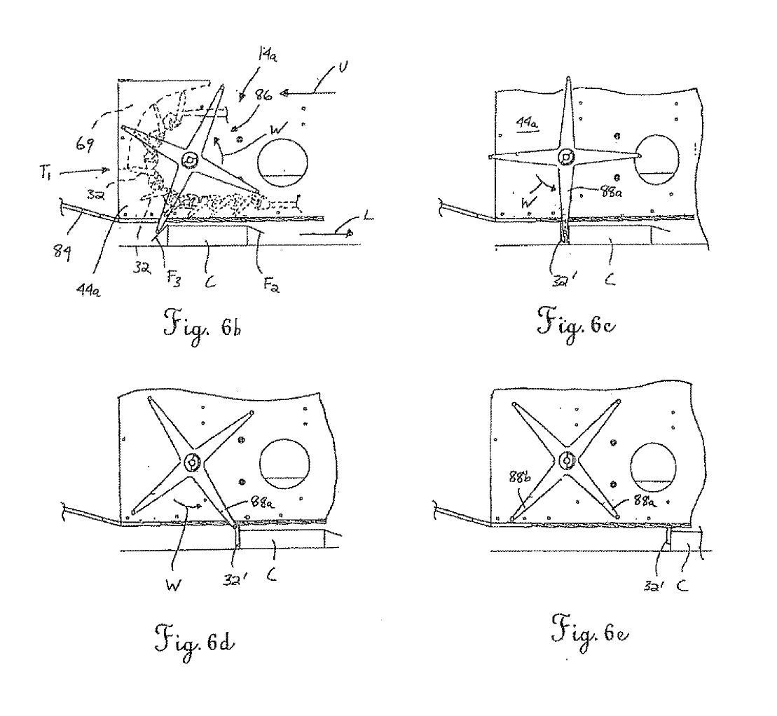

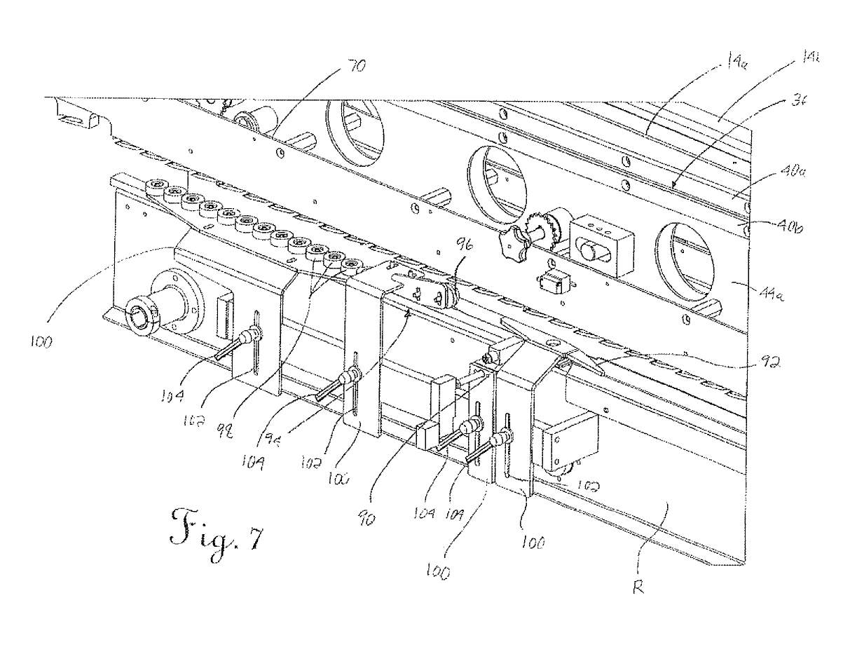

In the illustrated embodiment, the lugs 32 are oriented such that, when the pusher 60 of each is in the actuated position, the generally planar engagement face 62 is presented for engaging and pushing the carton along a trailing end (which with the trailing end flap F₃ in the folded condition is generally planar; see FIGS. 6d and 6e). However, as noted further in the description that follows, the lugs 32 could also be oriented such that the engagement face 62 of the pusher 60 contacts the carton along the leading end (and may thus be used to provide a squaring function as the carton is pushed along by either a belt conveyor or a bottom-running lug conveyor, or to hold the carton back while a pop-down lug is used to engage and fold an associated flap). A combination of the two approaches could also be used, either on the same conveyor in the case of lugs spaced far apart or different conveyors in the case of overlapping lugs. In either case, the engagement face 62 is preferably perpendicular to the horizontal plane when the lug 32 is actuated.

With reference again to FIG. 4a, each lug 32 includes a transversely extending projection or tab 66. Preferably, each tab 66 is specially contoured to include a first sloping or inclined leading face 66a for engaging a first surface of a diverter, such as a pivotally mounted finger 68. In the illustrated embodiment, the finger 68 is tapered and elongated in the conveying direction. The finger 68 may project from an elongated support structure 70 positioned adjacent to the conveyor 14a and, more particularly, along the lower run L thereof.

When in the home position as shown in FIG. 4b, a first side of the finger 68 may engage the leading face 66a of the tab 66 extending from each lug 32. This guides it into engagement with a first surface 72a of a guide structure 72 supported by the support member 70 and also forming part of the diverter. As a result, the corresponding lug 32 is maintained in the retracted position as it travels along with the chain 30. In this position, the elongated pusher 60 is incapable of engaging a carton in the conveying path by virtue of the captured nature of the corresponding transverse tab 66.

An optional guard structure 74 may be associated with each lug conveyor 14a, 14b. In the illustrated embodiment, the guard structure 74 comprises a plurality of flexible fingers 74a extending from the support member 70. The fingers 74 preferably extend in the conveying direction and prevent the pushers 60 of the lugs 32 in the retracted orientation from inadvertently engaging any portion of the cartons (e.g., the flaps, which may in some circumstances project slightly upwardly relative to the plane defined by the lid E) in the conveying path. Typically, the spacing of the lug conveyors 14a, 14b relative to the support surface for the cartons is such that sufficient clearance is provided to avoid any contact with the guard 74. Similar fingers (not numbered) may also be provided on the lower chain guide 41b.

When actuation of a particular lug 32 is desired, such as for engaging a portion of a fleeting carton adjacent to the conveyor(s) 14a, 14b, the finger 68 is pivoted (counterclockwise in FIGS. 4b and 4c to position 68′) to engage an different surface 66b of the corresponding tab 66. The pivoting movement may be provided by a corresponding motive device, such as a rotary solenoid 76 (see FIG. 4d), the actuation of which is controlled by the controller (see FIG. 13). Preferably, the pivoting is momentary and through a small angular range (e.g., a few degrees in the counterclockwise direction). As a result, only the transverse tab 66 of a single selected lug 32 is engaged but the projection of the next-in-line lug is not (even when the chains 30 are moving at high speeds; e.g., greater than 1 ft/s).

Initially, the engagement with the finger 68 in the actuated position causes the selected lug 32 to begin the pivoting sequence, such as by moving from a retracted position to approximately 10° pivoted (that is, the second pin 50b travels approximately 10° along the arc defined by the slot 52). The finger 68 when actuated guides the tab 66a into engagement with a second, adjacent engagement surface 72b at the upstream end of the guide structure 72, which is also considered to be located in the transition T₁ from the return run to the forward run. The portion of the engagement surface 72b at the upstream end of the guide structure 72 at the transition T₁ is curved or specially contoured such that the partially pivoted lug 32 moves to a more fully pivoted position (note phantom position 32″ in FIG. 4c) and ultimately to a fully pivoted position (32′ in FIGS. 4b and 4c), with the elongated pusher 60 now fully depending and ready to engage a portion of a carton or other object positioned on an adjacent support surface (such as a dead plate, an adjacent conveyor, a pair of spaced guide rails, etc.). With the partial pivoting created by the engagement with the finger 68, the total range of movement of the lug 32 in the preferred embodiment is about 60° (which means that the slot 52 defines an arc of about the same angle).

An optional guide structure 69 with a curved engagement face may also extend at least partially along the transition T₁ from the return or upper run U to the forward or lower run L (see FIG. 6). The engagement between the tip of the pusher 60 and the curved face of this guide structure 69 helps to resist the centrifugal and gravitational forces that tend to rotate each lug 32 toward the infeed end as it moves through the transition T₁. This in turn helps to ensure that the transverse tab 66 remains in the desired position for engaging the corresponding surface of the finger 68 such that it reaches the desired surface 72a, 72b of the guide structure 72.

As noted above, conventional lug conveyors typically include lugs spaced apart at relatively large, pre-selected intervals corresponding to the length of the carton in the conveying direction. The chain carrying the lugs is then driven at a speed corresponding to the rate at which the cartons are introduced (commonly referred to as a “timed” chain). To ensure smooth, uninterrupted operation, this timed chain arrangement requires that the cartons are fed in a timed sequence corresponding with the position of lugs. If the carton is early or the lug is behind, a delay may result while a catch up occurs. Alternatively, if the carton is not yet in a ready position for conveyance at the proper instant in time, the lug during actuation may inadvertently crash into the lid or underside of carton, resulting in permanent and severe damage (which can in turn lead to a jam in the machine and deleterious downtime to take the necessary corrective action).

With reference back to FIGS. 3a, 4a, and 4b, the lug conveyors 14a, 14b used in the preferred embodiment of the machine 10 avoid this problem by closely spacing the of lugs 32 along the chain 30. In the most preferred embodiment, the distance D from a point on any leading lug, such as the center, to the corresponding point on the next-adjacent trailing lug in the retracted or normal position (commonly referred to as the “pitch”) is about 2.5 inches. In this embodiment, this distance D is less than the width of each lug in the conveying direction (such that at least three lugs in the normal position are provided for each foot of chain 30). Consequently, the leading and trailing lugs 32 fully overlap with one another, even in the retracted normal condition. Preferably, the overlap occurs in the conveying direction (parallel to action arrow L in FIG. 3a) or a direction generally transverse to the conveying direction and the vertical direction (e.g., perpendicular to action arrow L and in the same horizontal plane), depending on the orientation of the lugs 32. In other words, a trailing part of each leading lug (such as the pusher 60) at least partially covers a leading part of each trailing lug, both along the upper and lower runs U, L.

This close spacing provides the lug conveyors 14a, 14b with a small, variable pitch. When the chains 30 are moving at high rates of speed, the lugs 32 are thus essentially infinitely actuatable at a desired instant in time at any location along the endless path where the diverter (finger 68) is positioned. Consequently, by positioning the diverter at the transition T₁ to the forward run, an adjacent carton may be engaged and conveyed at the point of introduction without the need for precisely timing the infeed to ensure that a smooth, uninterrupted operation is maintained. Even in the situation where the cartons are randomly fed, the ability to selectively actuate the lugs (and thus vary the pitch of the actuated lugs on the chain 30) reduces the time required between the carton reaching the position for conveyance and the actual engagement with the lugs in the actuated position. A significant increase in throughput is therefore possible with enhanced reliability. Advantageously, the use of pusher lugs 32 also avoids the possible skewing created when the carton is conveyed via frictional engagement with top and bottom-running belts.

With reference now to FIG. 5a, one possible mode of operation of the machine 10 is to deliver the partially formed cartons to a stable support surface, such as a pair of spaced, elongated support rails 78, positioned adjacent to the intermediate conveyor 14 and along the conveying path. The carton may be introduced at a constant speed using the belts 22, and the leading end may be detected by adjacent position sensor 80 (which may comprise a photo-electric, through-beam type sensor with an opposed transmitter and receiver). Based on the known dimensions of the carton, which may be inputted by the operator to the controller via an interface (such as a touch screen 82; see FIGS. 1a and 1b), the known position of the leading end (as determined by sensor, which may generate a corresponding output signal), and the known speed of travel of the carton (as determined by the infeed belts 22, and may be adjusted by the operator depending on the desired throughput), the finger 68 may be actuated at the desired instant in time such that a single lug 32 of each conveyor 14a, 14b moves to the actuated or depending condition to engage and convey the carton. The selective actuation of the lugs by the finger 68 along the transition T₁ ensures that only a selected lug is engaged just in time for engaging the carton (which is spaced from the next-in-line carton by the metering wheels 18) in the desired fashion. The operation is thus smooth and efficient, which allows for an increase in throughput without a concomitant increase in downtime to clear deleterious jams.

In the typical arrangement, the partially formed and filled carton C is introduced to the machine 10 with the lid E or closure in an open state and the flaps unfolded, as shown in FIG. 1c. Consequently, as the carton enters the machine 10, the lid E must be moved toward the closed position in order to allow for the folding and sealing of the associated flaps. In the preferred embodiment, the closing of the lid is accomplished by a static plow 84 for engaging the generally vertically oriented lid and automatically folding it as the carton approaches the intermediate conveyor 14. When the lid E is closed, a first side flap F₂ of the carton remains unfolded along the leading end and the second side flap F₃ remains unfolded along the trailing end. In this orientation, the front side flap F₁ faces the front of the machine 10 as it appears in FIGS. 1a and 1b. This is known as a “narrow end” leading configuration (that is, the narrower lateral side of the rectangular carton is the leading or front edge). However, it should be appreciated that the converse configuration may also be used in cartons where the side flaps are on the elongated sides of the carton (although an adjustment in the spacing of the lug conveyors 14a, 14b may be necessary).

Engaging the carton with the trailing end flap F₃ in the unfolded condition using lugs 32 is undesirable in most instances, since damage may result. To avoid this situation, the trailing end flap F₃ of each carton introduced to the machine 10 may be at least partially pre-folded before being engaged by the lugs 32. In the illustrated embodiment, the pre-folding of this flap F₃ is accomplished using a rotatable wheel 86 including one or more radially extending projections or legs, which thus form fingers or paddles 88 adapted for engaging the trailing end flap F₃ (FIGS. 5a-5c) The wheel 86 is preferably positioned between the lug conveyors 14a, 14b such that when it is rotated, a paddle 88 moves into engagement with the trailing end flap F₃ and at least partially folds it prior to engagement with the selected lugs 32 in the actuated position. In the illustrated embodiment, the wheel 86 includes four paddles 88 (each with an optional transversely extending foot 89), and is thus intermittently rotated one quarter turn to cause the corresponding paddle 88a to advance into engagement with the trailing end flap F₃. The rotation may be effected by an onboard motive device, such as a motor M₄. Suitable gearing 90 may also be used to ensure that a full or partial turn of the output shaft of the motor M₄ effects the desired amount of rotation in the wheel 86 to fold the flap and retract the corresponding paddle from the conveying path.

Thus, in another, more preferred mode of operation, as shown in the progressive views of FIGS. 6a-6d, the carton C is introduced to the intermediate conveyor 14 traveling at a generally constant and known speed as the result of the infeed belts 22 (which as perhaps best shown in FIG. 6a may extend at least partially beneath the adjacent overhead conveyor 14). As the carton is conveyed along by the belts 22, the position of the leading end adjacent to the side flap F₂ is detected using sensors 80, and the length in the conveying direction is known from the operator input. Consequently, the moment in time when the trailing end flap F₃ is adjacent to the corresponding paddle 88a may be determined by the controller (which receives the output signal from the sensor 80 that is used to actuate the wheel 86). At that instant, the wheel 86 is rotated (note counterclockwise action arrow W) such that the next-in-line paddle 88a sweeps into the conveying path (FIG. 6b) to engage and at least partially fold the trailing end flap F₃ (FIG. 6c).

At about the same instant in time, corresponding lugs 32 associated with the lug conveyors 14a, 14b are also selected for actuation by momentarily pivoting the fingers 68 associated with the lug conveyors 14a, 14b. The lugs 32 selected for actuation thus move into the conveying path slightly behind the at least partially folded trailing end flap F₃ (FIG. 6b). Preferably, the timing is such that the lugs 32 catch up with the carton C to engage and convey it just as the trailing end flap F₃ is partially folded (at which point the conveying influence of the belts 22 is no longer necessary). The lugs 32 may then, and possibly for only a brief instant in time, simultaneously engage the at least partially folded flap F₃ with the paddle 88a and convey the carton along (and possibly complete the folding, depending on the timing). Eventually, the carton advances to a point where the paddle 88a disengages from the trailing end flap F₃ (FIG. 6d).

Continued rotation of the pre-folding wheel 86 retracts or withdraws the paddle 88a from the conveying path and to a position between the lug conveyors 14a, 14b (FIG. 6e). Simultaneously, the next-in-line paddle 88b moves to a ready position for engaging the trailing end flap F₃ on a next-in-line carton. In this particularly preferred embodiment, the combined use of the pre-folding wheel 86 and the selectively actuated, small pitch (overlapping) lugs 32 with the corresponding diverter (finger 68) positioned at the transition T₁ advantageously provide for smooth, efficient, and reliable operation, even at high throughput speeds (e.g., 120 cartons per minute).

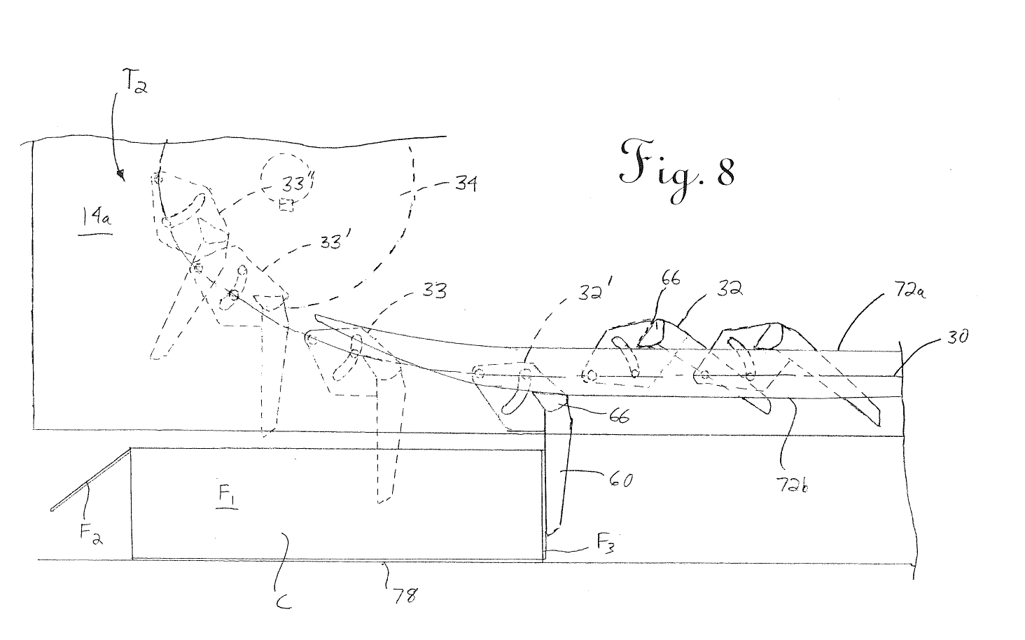

Turning now to FIG. 7, as the carton is conveyed along by the depending lugs 32, the front or “broad” side flap F₁ is folded and sealed. In the illustrated embodiment, an adhesive is applied to the sidewall of the carton using a gun 90 or like device positioned adjacent to the conveying path. A stationary plow 92 protruding into the conveying path may engage the underside of this broad side flap F₁ as the carton is conveyed. A downstream roller assembly 94 includes one or more strategically oriented roller wheels 96 (e.g., two mounted for rotation about a horizontal axis; two mounted for rotational about a vertical axis) for engaging and completing the folding of the flap F₁ with the assistance of the plow 92. Next, a series of downstream compression discs 98 receive the folded flap F₁ and apply gentle pressure as the carton is conveyed. This helps to ensure that the adhesive sets such that a proper seal is formed such that the lid is correctly registered. It should further be appreciated that, during this folding sequence, the engagement between the pushers 60 of the actuated lugs 32′ and the trailing end of the carton C (see FIG. 6e) helps to ensure that the lid E or closure is maintained in the proper position.

The adhesive gun 90, plow 92, roller assembly 94, and compression wheels 98 are preferably each height-adjustable to accommodate cartons having different heights. Specifically, the mount 100 for each structure may include a vertically oriented slot 102. A shaft (not shown) supported by the frame M of the machine 10 or an extension thereof passes through the slot 102. A manually operable, quick-release fastener 104 associated with the end of each shaft may fix the relative position of each mount, as desired to ensure that the broad side flap F₁ is folded and sealed in the proper fashion. Once the proper adjustment of these exemplary folding and sealing structures is made for a carton having a particular size and structure, re-adjustment should be unnecessary.

After the broad side flap F₁ is folded and sealed, the depending or “pop-down” lugs 32 continue to push the carton along the guide rails 78 and eventually eject it from a discharge end of the intermediate conveyor 14 opposite the end associated with the infeed conveyor 12. As disengagement occurs, the actuated lugs 32′ may be automatically drawn out of the conveying path in a generally vertical direction as a result of the movement of the corresponding chain in the guide track 36 and the contour of the guide surface 72b at the opposite end of the support member 70. This disengagement allows the trailing end flap F₃ to return to at least a partially unfolded position (which occurs naturally, since the carton was initially formed from a generally planar blank including this flap).

More specifically describing the movement of the actuated lugs 32′ at the discharge end of the intermediate conveyor 14, and with continued reference to FIG. 8, the guide structure 72 initially may continue to engage the transverse tab 66 of each lug 32. Toward the end where the transition T₂ to the return or upper run U begins, the guide structure 72 also includes a curved or contoured surface 72b for engaging the tab 66. The contour of this surface 72b and the contour of the guide track 36 for the chain are such that the transition to the retracted position is made in a gradual fashion. Consequently, the pusher 60 of the actuated lug 32′ remains in a ready position until withdrawn from the conveying path and does not interfere with the orientation of the squared carton (note phantom positions 33 and 33′). In other words, the pusher 60 is withdrawn from the actuated or operative position (corresponding to lug position 32′) in a generally vertical direction, at least until it is away from the path of the squared carton.

Also noteworthy is the fact that the withdrawal of the lugs 32 and return to the retracted position are also accomplished in a passive manner. This avoids the need for pivot blocks or like structures that actively engage and “kick back” the actuated lugs. Wear is thus reduced and the service life increased.

The guide structure 72 ultimately terminates, which in the “pop-down” version of the lug conveyors 14a, 14b allows the corresponding actuated lug 32 to rotate toward the retracted or home position slightly (note position 33″), such that pin 50b engages the upper end of the slot 52. However, as the corresponding chain 30 is driven forward over the sprocket 34 and toward the return/upper run U, the lug 32 is then rotated or pivoted in the opposite direction as the result of the combined centrifugal and gravitational forces acting on it (see FIGS. 3a and 3b). In terms of pivoting movement, the lug 32 ultimately comes to rest in the generally retracted or home position, and remains in this position as the chain 30 is driven in an endless fashion until it is again selectively actuated by the diverter (e.g., finger 68).

Referring now to FIGS. 9-12, the carton upon being ejected from the intermediate conveyor 14 may engage a stop 106 and momentarily come to rest on a support surface S associated with the takeaway conveyor 16. The takeaway conveyor 16 is generally oriented with a conveying direction generally perpendicular to the intermediate conveyor 14, and is actually comprised of a pair of spaced, generally parallel lug conveyors 16a, 16b. Similar to the lug conveyors 14a, 14b of the intermediate conveyor 14, each lug conveyor 16a, 16b may include an endless chain 108 driven along through a guide track 110 by a sprocket 112 associated with motor M₅. The chain 108 of each conveyor 16a, 16b carries a plurality of selectively actuatable lugs 132, which may be essentially identical to the lugs used in the intermediate conveyor 14 and thus are pivotally connected to the chain 108 by pins 150a, 150b (with pin 150b positioned in an arcuate slot 152 formed in the lug 132) in a closely spaced or overlapping fashion. The primary difference is that the lugs 132 are selectively actuated as the transition is made from a lower return run L to an upper forward run U to engage and convey the carton along the takeaway conveyor 16 (such as by way of engagement between the generally planar front face of the upstanding pusher 160 and the rear face of the carton).

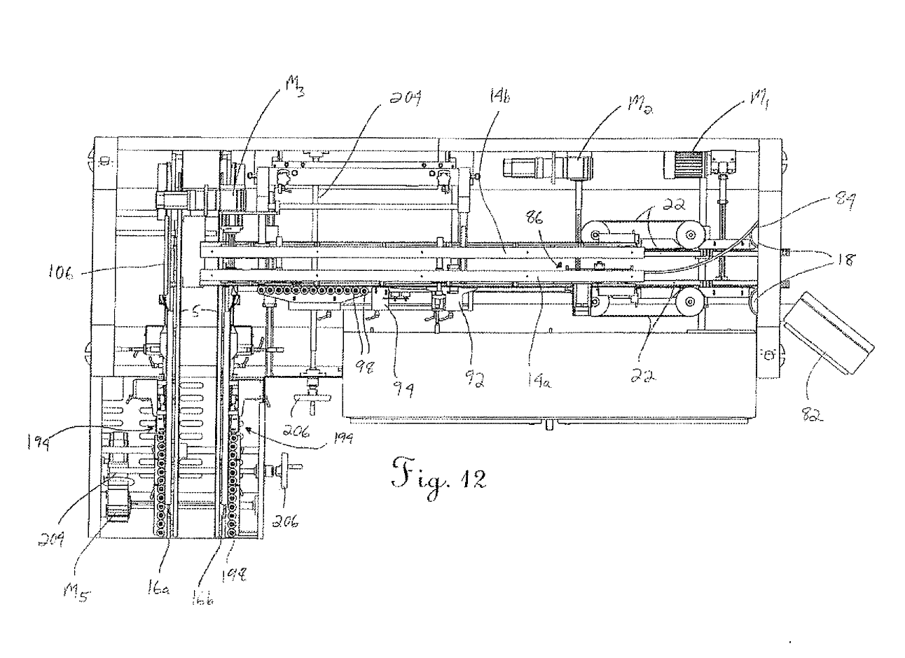

As with the lugs of the intermediate conveyor 14, each may be selectively actuated by moving a diverter (such as a pivoting tapered finger 168 associated with a rotary solenoid 176; see the side schematic view of the upstream end of the lug conveyor 16b in FIG. 11) between a home or non-actuated position and an actuated position (which may be effected as the result of a sensor 180 that detects the carton on or adjacent to the takeaway conveyor 16). The finger 168 in a normal or home position guides the projection 166 on the lug 132 into engagement with a corresponding guide surface 172a of a guide member 172 and an actuated position 168′ that guides the projection 166 into engagement with the opposite guide surface 172b. Consequently, the lug moves from the retracted position (132), to a partially pivoted position (132″), and ultimately to a fully actuated position (132′). Since the actuated lugs 132′ engage the surface of the carton opposite the broad side flap F₁ in this preferred embodiment, no pre-folding step is necessary.

During conveyance along the takeaway conveyor 16 by the lugs 132, the side flaps are folded and sealed to complete the carton. As perhaps best shown in FIG. 9, an adhesive is applied to each side of the carton by a pair of spaced guns 190, and the narrow side flaps F₂, F₃ then pass a stationary plow 192. An assembly 194 includes one or more roller wheels 196 strategically positioned adjacent to each conveyor 16a, 16b for folding the flaps F₂, F₃ in association with the plows 192. The folded side flaps F₂, F₃ are then each engaged by serially arranged discs 198 that provide a slight compressive force and ensure a proper seal is formed as the adhesive sets. The glue gun 190, plow 192, roller wheels 196, and discs 198 may be supported by mounts 200, including quick-release handles 202 (see FIG. 10) to facilitate manual adjustment.

Advantageously, the immediate engagement resulting from selectively popping-up or extending the lugs 132 at the instant in time when the carton C with the registered, folded lid E reaches the takeaway conveyor 16 helps to improve the speed of the overall feeding and forming operation. Additionally, since the takeaway conveyor 16 is at a right angle to the intermediate conveyor 14, this most preferred arrangement avoids the need for an active mechanism, such as belts running at differential speeds, for turning the carton 90° (e.g., from a narrow side leading orientation with the side flaps in the leading and trailing positions to a “broadside leading” orientation) before an additional operation is performed (such as in a downstream flap closing section). This tends to reduce the amount of continuous floor space required by the machine 10 in any single direction and allows for a concomitant increase in throughput. As should be appreciated, the takeaway conveyor 16 may be positioned for conveying the cartons in either direction (that is, to the right of the machine 10 when facing that side, or to the left of the machine), depending on the particular environment of use.

In a preferred embodiment, the lugs 132 are withdrawn from the conveying path in the vertical direction (consider FIG. 8 inverted) while the carton is engaged by the wheels 198. As a result, the carton is not ejected from the takeaway conveyor 16 by the lugs 132. Instead, the engagement with the next-in-line completed carton serves to engage and eject the previously completed carton from the takeaway conveyor 16 (such as onto another conveyor; not shown). This vertical withdrawal prevents the lugs 132 from inadvertently damaging the cartons, which are merely ejected as a result of the slight push forward provided by the engagement by the next-in-line completed carton.

As should be appreciated, the use of small pitch, selectively actuated lugs allows for the machine 10 in the preferred embodiment to be readily adapted for use with cartons having different lengths in the conveying direction. In the preferred embodiment, the infeed conveyor 12, intermediate conveyor 14, and takeaway conveyors 16 are all adjustable to accommodate cartons of varying widths. For example, the intermediate 14 and takeaway conveyors 16 may be provided with jackscrews 204 that are manually controlled by hand wheels 206 to adjust the spacing of the lug conveyors 14a, 14b; 16a, 16b. Preferably, the actuation point for the lugs 132 on the takeaway lug conveyors 16a, 16b is sufficiently far upstream to accommodate a significant increase in the spacing of the intermediate lug conveyors 14a, 14b. To avoid the need for adjusting the position of the corresponding motors, the output shafts may be telescopingly connected to the drive shafts associated with the sprockets 34, 112 via splined interface. Instead of manually operated jack screws, automated linear actuators or ball screws may also be used for adjusting the spacing of the lug conveyors 14a, 14b; 16a, 16b to accommodate the cartons (in which case the adjustments could also be made automatically based on operator input via tough screen 82).

It is also possible to provide a similar motive device (e.g., linear actuator or jack screw) for adjusting the vertical position of the overhead lug conveyors 14a, 14b relative to the support surface, such as guide rails 78, to accommodate cartons having increased heights. The range of adjustment in the machine of the preferred embodiment may be limited by the fact that the lugs 32 are of fixed length. To avoid this, it may be possible to use lugs that, in the extended condition, extend through the space provided between the guide rails 78. A significant height adjustment to the conveyor 14 could then be made with the lugs still extending well into the conveying path.

FIG. 13 is a block diagram illustrating the associations maintained between the controller 300, the input device (such as touch screen 82), and the various motors, sensors, and rotary solenoids. As should be appreciated, the controller 300 may be an onboard computer programmed to receive input from the sensors and the input device and provide corresponding output to the motors and solenoids to control the speed/throughput and operation of the machine 10.

Although the arrangement described above as the preferred embodiment includes the pre-folding wheel 86, it is also possible to use the machine 10 without this structure and to practice a related method of feeding and forming cartons. Instead, the feeding of the cartons could be regulated such that the instant in time when the trailing end flap F₃ is in a proper position for folding is known. The selected lugs 32 could then be actuated at regular intervals to contact this flap F₃ at that instant in time to fold it, and then convey the carton along with this flap held in the folded condition. In other words, the pop-down lugs 32 could be used to both fold the trailing end flap F₃ and convey the carton. In the case where the lugs 32 are overlapping or very closely spaced, the small pitch would allow for actuation very close to the instant in time when the flap F₃ is in the optimum position for folding. The use of pop-down lugs 32 is also advantageous in this situation, since the lug 32 during actuation contacts the strong planar upper surface of the flap F₃, as opposed to the weaker edge (as would occur with pop-up lugs). While this proposal obviously simplifies the machine 10 in some respects, it complicates the overall process by requiring timed infeed of the cartons. It also tends to slow the carton forming process, as compared to the random feed approach. Thus, it may be desirable only when warranted by the particular circumstances.

Another approach is to use a bottom-running lug conveyor (not shown) in concert with the overhead conveyor 14. The lugs of the bottom running conveyor may have their engagement faces oriented towards the infeed end and engage an introduced carton. In addition to squaring the carton, the upstanding lugs could be used to provide a temporary hold back function while the depending lugs are actuated to engage the trailing end flap and convey the carton. The upstanding lugs could then be withdrawn from the conveying path. It is also possible to use a single overhead lug conveyor in such an arrangement.

Briefly summarizing the foregoing, a machine 10 for intended use in feeding and completing partially formed cartons is disclosed. The machine 10 includes an overhead conveyor 14 that receives partially formed and filled cartons C from an infeed conveyor 12. The conveyor 14 includes lugs 32 that in a selectively actuated, depending position (32′) engage and convey the carton C in a first direction while a first flap F₁ on a lid E or closure is folded. A perpendicular takeaway conveyor 16 includes lugs 132 that in a selectively actuated, upstanding position convey the carton in a second direction while second and third flaps F_{?}, F₃ on the lid E are folded. The lugs 32, 132 may be closely spaced or overlapping to allow for selective actuation at a desired instant in time for engaging a carton or other object introduced into the conveying path. A diverter including a tapered finger 68 or 168 is provided at a transition between the forward and return runs of the overhead and takeaway conveyors to actuate the lugs 32, 132.

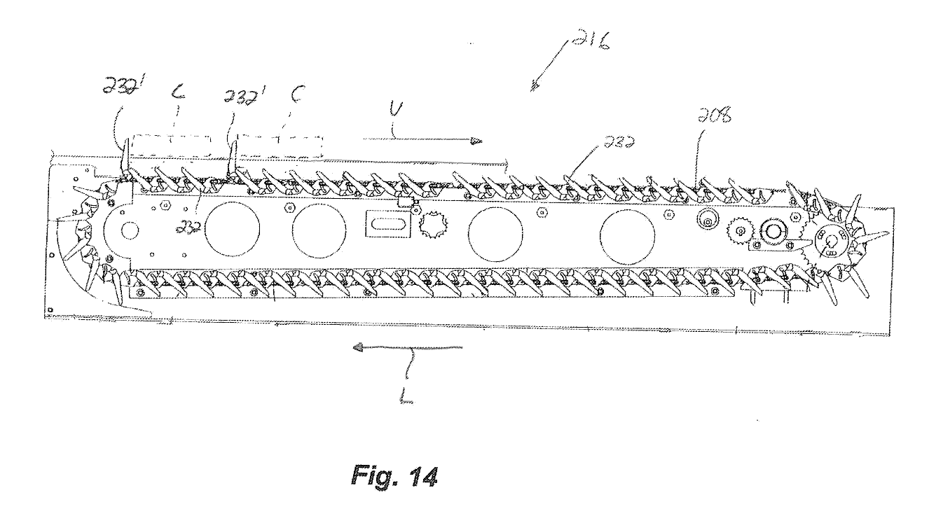

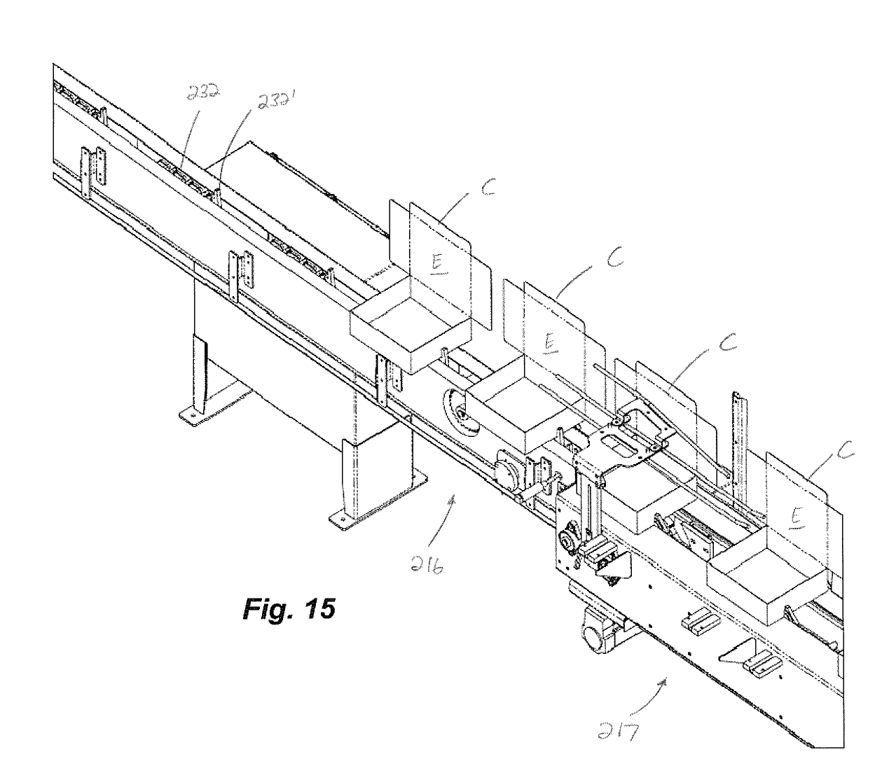

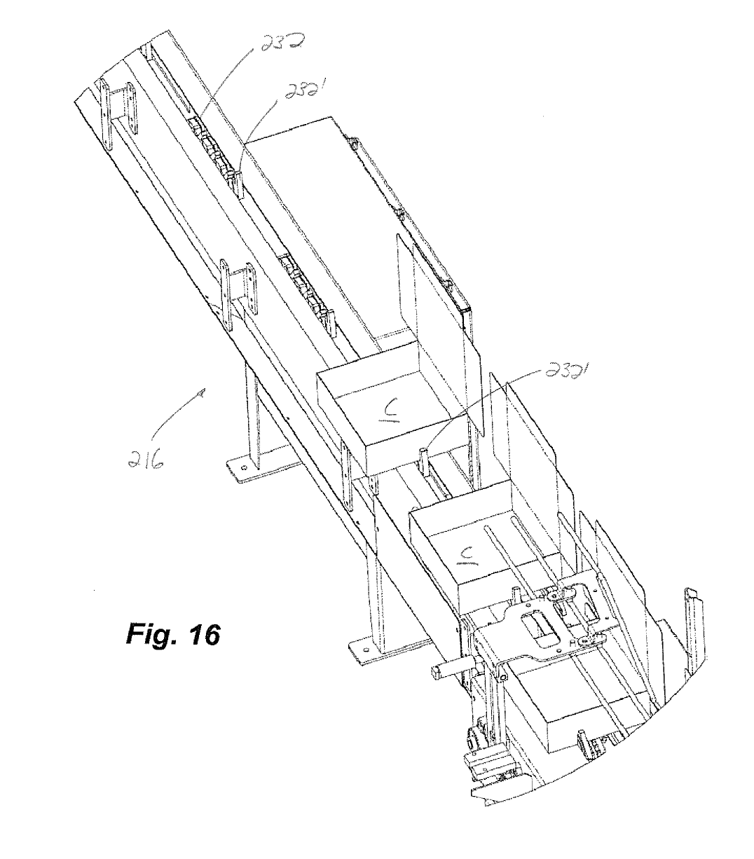

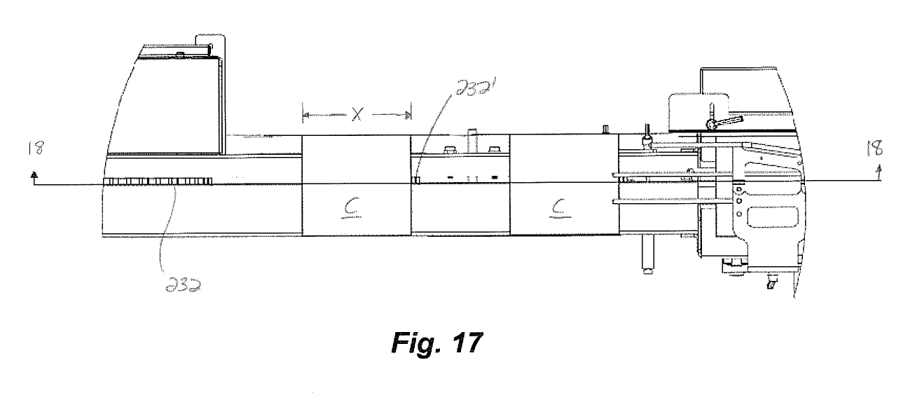

In accordance with another aspect of this disclosure, and with reference to FIGS. 14-18, a conveyor 216 (which is shown as being similar to takeaway conveyor 16) may be used in an “in-line” configuration to convey products, such as partially formed or filled cartons C, which may be fed in a regular (that is, not random) fashion by an upstream infeed conveyor 217. In the illustrated embodiment, the conveying path is formed along an upper run U in a conveying direction (note arrowhead) and is defined at least in part by a stable support structure or surface including a passage elongated in the conveying direction for allowing the lugs to pass when actuated.

Preferably, the conveyor 216 includes at least one endless or continuous chain 208 carrying a plurality of lugs 232 (which are preferably spaced a distance in the non-actuated condition that is less than the length of the carton in the conveying direction and, most preferably, are arranged so as to overlap each other in the conveying direction). An actuator, such as for example the diverter described in detail above may be used for selectively actuating one or more of the lugs to convey the cartons. An associated folder or hold down device may also be provided for engaging the lid or flaps of the cartons C during conveyance.

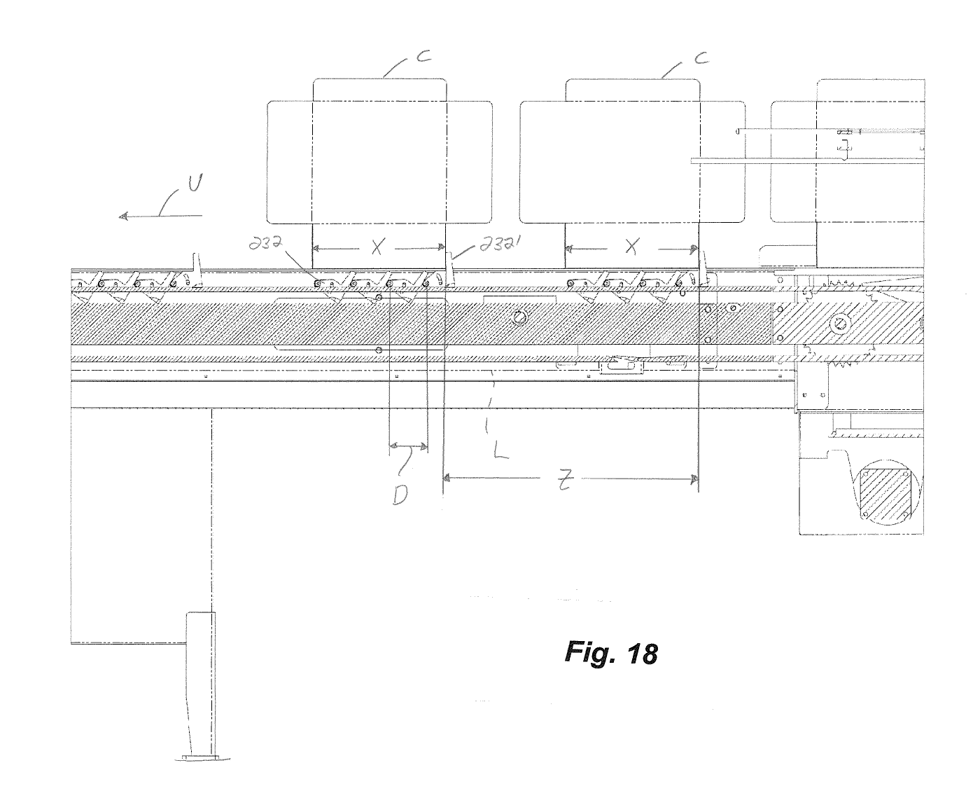

In a specific implementation, selected lugs are actuated in a particular sequence to accommodate a feed stream of the partially formed or partially filed cartons C arranged in tandem. Thus, as shown in FIG. 14, one of every N lugs (where N is a positive integer greater than one when adjacent lugs are spaced apart a distance D less than the length of the carton in the conveying direction X; see, e.g., FIG. 18) may be selectively and sequentially actuated for engaging a carton or like product received from an infeed conveyor in accordance with a first actuation sequence.

Timing of lug actuation may be controlled by determining the passing of a certain number of the non-actuated lugs adjacent a given location. This can be achieved by counting the lugs, such as based on an output signal from a sensor (such as a photodetector or the like; not shown) adapted to sense the passing lugs and issue the appropriate signal for actuation (such as by moving the diverter into the path of the lug), or alternatively by using the output of an associated servomotor (e.g., the position feedback from the servomotor encoder, which measures the position of the motor throughout its operation) for driving the associated chain (which can be used with the known pitch of the lugs to determine the exact instant in time when actuation of the diverter is required to effect lug actuation).

In any case, a controller functions to receive the output signal from the sensor or motor and then cause the diverter to actuate and cause the selected lug to move from the non-actuated condition to the actuated condition at the desired instant in time (as determined by the known position of the chain from the servomotor position encoder) for engaging the trailing end of a next-in-line carton in need of conveyance. The controller may comprise a computer programmed with instruction for carrying out the disclosed algorithm (with the variables being the carton length in the conveying direction, the relative pitch of the lugs, and the linear speed of the associated chain (such as obtained from the servomotor encoder), for which the associated drive motor may also be controlled by the controller).

Thus, as a more specific example, an upstream carton forming machine (not shown) may be used to simultaneously form and deposit a plurality of cartons in tandem onto an infeed conveyor, with the cartons having a length in the conveying direction X. Selected lugs 232 in the non-actuated condition on the downstream conveyor 216 are then actuated sequentially (see lug 232′) such that the lug-to-lug spacing, or “pitch” of the actuated lugs in the conveying direction (Z) is greater than or equal to the carton length, X, and preferably as close to the carton length as possible (see, e.g., FIG. 14). For example, in the case where the lugs have a pitch of about 2.5 inches, as noted above, every fourth lug 232′ (N=4) may be actuated for engaging a carton C being fed in a regular fashion from an upstream infeed conveyor and having a corresponding dimension in the conveying direction of 10 inches or less (e.g., 9 inches).

As noted above, lug actuation preferably occurs along the transition of the associated chain 208 from the return or lower run L to the forward or upper run U. Consequently, the actuated lug 232′ enters the conveying path in an upright condition just as the trailing end of the carton passes to provide smooth, efficient, and continuous conveyance. At the opposite end of the conveying path, the actuated lug 232′ may be retracted or returned to the non-actuated condition, preferably in a gradual fashion as outlined in the foregoing description.

Not only does this mode of operation advantageously provide for exceptionally smooth and efficient conveyance, but it also allows for changes to be made to vary the lug pitch “on the fly.” Thus, for example, in the event the infeed device (e.g., conveyor 217) begins delivering cartons having a different length (shorter or longer), or the carton feeding or forming machine is adjusted to drop more cartons, then lug actuation may be adjusted accordingly by simply changing the timing to a second alternating sequence comprising actuating every N±M lugs, where M is also a positive integer. More specifically, where the lugs are spaced about 2.5 inches apart (i.e., D=2.5) and a series of longer cartons, each having a length in the conveying direction of approximately 12 inches, is subsequently delivered to the infeed end, then instead of every fourth lug as was done in the first sequence (N=4), every fifth lug (second sequence, M=1) may be actuated to create a total lug-to-lug spacing of about 12.5 inches (such as by sensing or determining the passing of the previous four lugs prior to actuating the diverter). Likewise, using this same 2.5 inch pitch value (which of course may vary), a subsequent carton having a length of four inches (i.e., X=4) in the conveying direction can be in a five inch variable flight (pop up every other lug; first sequence N=4, second sequence M=2) and a corresponding six inch carton can be in a 7½ inch flight (pop up every third lug; first sequence, N=4; second sequence, M=1)). As should be appreciated, this change in pitch may be infinitely adjusted.

In view of the fact that the lugs are actuated to create each flight during the operation of the conveyor, the resulting flight pitch is not limited by physical conveyor length, as in the conventional approach where lugs are carried by a conveyor chain in a manner that defines a fixed pitch. Furthermore, the continuous chain length is not limited to be an integer multiple of the flight pitch as it would for a conventional lugged conveyor. In the same way, the physical conveyor length is not limited by the necessary length of a fixed flight pitch continuous chain. Thus, one aspect of the disclosure relates to a flighted conveyor where the length of the chain does not have to be an integer multiple of the flight pitch (see, e.g., FIG. 3a, in which D=2.5 inches, and 62 lugs are present, for a chain length of 155 inches, with a corresponding flight pitch of 10 inches, so the length of the chain is not an integer multiple of the flight pitch, but is 15.5).

As should be further appreciated, the adjustments may be achieved without stopping, or possibly without altering or adjusting, the speed of the chain carrying the lugs. Advantageously, this will maximize the density of cartons or products being conveyed. Thus, for example, if every fourth lug is being actuated for moving a carton having a length of 10 inches or less, the actuation sequence can change to every third lug for a carton having a length of 7.5 inches or less. If for example the length of the forward run of the conveying path is 150 inches, this means that the machine would switch from conveying 15 cartons at a time to 30 cartons at a time, without any change in the speed of the lugs or the underlying chain conveying them (which of course is a result of the associated motor). This is particularly significant in applications where robots or the like are used to load the cartons being conveyed, since more cartons can be loaded in a more efficient fashion than would be the case if the chain speed were simply increased. This advantageously enhances process efficiency.

In the case where the length of the chain travel for unit time is used as the metric for determining when lug actuation should occur, also proposed is a manner in which to compensate for changes in the elongation of the chain carrying the lugs 32, 132, 232 over time. In one example, this is achieved by comparing the position of a fixed object, such as the drive motor at one end of the conveyor, with the sensed location of the lugs at a different location sensor (which in the preferred embodiment is at the opposite end, and may involve using a sensor similar or identical to the one used for actuation purposes). Thus, in the case where the chain stretches over time, changes in the relative spacing of the lugs can be determined using the comparison and adjustments made in the actuation to compensate accordingly. This is facilitated by the particularly close spacing of the lugs 32, 132, 232, which again are spaced less than the length of the carton in the conveying direction and most preferably at least partially overlap in the conveying direction.

As noted above, it is also possible to sense the in-feeding cartons using a sensor. In the event no carton is present, the machine may sense this and abort actuation of the corresponding lug. This reduces not only wear, but also the potential for catastrophic failure for the non-actuated lug.

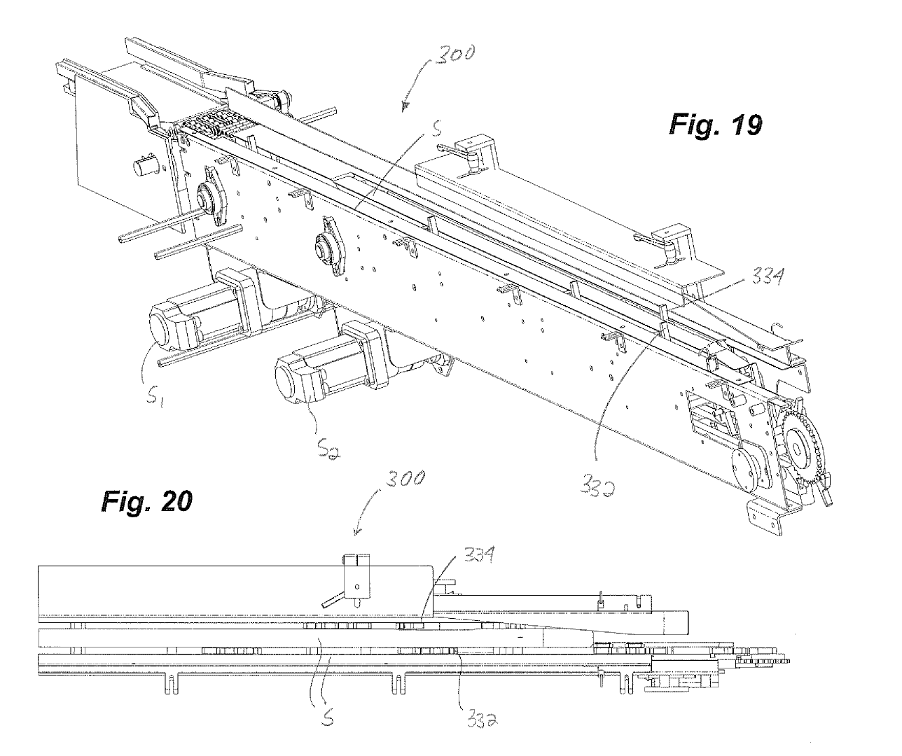

It is also possible to use this type of variable pitch conveyor in a machine where different sizes of cartons had to be confined between two lugs. In such case, and with reference to FIGS. 19-20, the conveyor 300 may include two servomotors S₁, S₂. A first servomotor S₁ is for conveying a chain including a plurality of lugs that are closely spaced and overlapping, and on actuation provides a first lug 332 for engaging the carton. The second servo motor S₂ may be associated with a second chain including a plurality of lugs that are closely spaced and overlapping, and on actuation provides a second lug 334 alongside the first chain, which both may form part of the same conveyor 300. On the second chain, the lug spacing is the same as the first chain and thus the spacing of the lugs is the same. However, the actuated lugs on these chains may be offset so that the actuated lug 334 on the second chain holds the leading end of the carton and the actuated lug 332 on the first chain holds the trailing side of the carton and pushes the carton. The stationary support surface S thus includes two passages for the lugs 332, 334 associated with the adjacent chains running in parallel.

This approach may be useful when the conveyor is intermittent in operation for purposes of filling product and the cartons may thus slide beyond the filling position when the conveyor stopped. For example, where the product was fed from the side of the conveyor and at fixed spacing along the length of the conveyor, the product could be presented to the conveyor 12 at a time. If the cartons were 2 products wide (a four count package for example), the machine would fill 6 cartons at a time and the cartons would be confined in a pitch that is 2 products wide. However, if the cartons are 3 products wide (a six count package for example), the machine would fill only 4 cartons at a time. In both cases, the product spacing would be the same, but the conveyor flights may differ and since the conveyor action may be intermittent and the carton placement during the filling process is an important consideration, it may be desirable to add this type of second “confining” lug that mounted on a second continuous chain (and with the same variable pitch as described herein).

The foregoing description has been presented for purposes of illustration and description. It is not intended to be exhaustive or to limiting. For example, the closely spaced or overlapping lugs may be used for conveying or engaging objects being conveyed in other types of carton feeding and forming machines (such as those with belts traveling at differential speeds to provide the turning function), as well as in machines besides carton feeding and forming machines. Also, although the use of static folding structures (e.g., plows and wheels) is preferred for sake of simplicity, the use of other means for folding/sealing is possible. For example, movable devices (e.g., extensible fingers) could be used for folding the side flaps F₁, F₂, F₃ as the carton is conveyed along. Instead of using a glue gun, cartons with pre-applied, heat-activated adhesives or coatings could also be used (in which case the “gun” would instead supply focused, heated air to activate the adhesive or coating in advance of the folding of the corresponding flap). The embodiments described provide an illustration of the inventive principles and the practical application thereof sufficient to enable one of ordinary skill in the art to utilize them in various other embodiments and with various modifications, as are suited to the particular use contemplated. All such modifications and variations are within the scope of the invention as determined by the appended claims when interpreted in accordance with the breadth to which they are fairly, legally and equitably entitled.

1. A machine for conveying a plurality of partially folded and formed cartons along a conveying path in a conveying direction, each carton having a length in the conveying direction between a leading and a trailing end, comprising:
a conveyor for conveying a plurality of lugs selectively movable from a non-actuated condition to an actuated condition for engaging the trailing end of the carton and conveying cartons along the conveying path in the conveying direction, with adjacent lugs in at least the non-actuated condition being spaced apart a distance in the conveying direction less than the length of a single carton in the conveying direction; and
an actuator for actuating a first lug for engaging the trailing end of a first carton and a second lug for engaging the trailing end of a second carton and spaced from the first lug by N lugs in a non-actuated condition, where N is a positive integer greater than one.

2. The machine according to claim 1, wherein the conveyor comprises a bottom-running conveyor including a stationary support surface for supporting the cartons.

3. The machine according to claim 2, wherein the support surface comprises a passage for the lugs in the actuated condition.

4. The machine according to claim 1, wherein the actuator comprises a diverter.

5. The machine according to claim 1, wherein the actuator actuates at least every other lug.

6. The machine according to claim 1, wherein the actuator actuates the second lug spaced apart a distance from the first lug by an amount L, wherein L is a linear distance necessary to accommodate the carton in the conveying direction.

7. The machine according to claim 1, further including a motor for driving a chain carrying the plurality of lugs.

8. The machine according to claim 7, wherein an output signal relating to the position of the motor is used to actuate the actuator to move a selected lug to the actuated condition.

9. The machine according to claim 7, further including a controller for controlling the motor to drive the chain at a first linear speed during a first lug actuation sequence.

10. The machine according to claim 9, wherein the machine controls the motor to drive the chain at substantially the first linear speed during a second lug actuation sequence having a different number of actuated lugs per unit of linear distance in the conveying direction than the first lug actuation sequence.

11. The machine according to claim 1, wherein the actuator provides a first alternating sequence for actuating every N lugs, followed by and a second alternating sequence for actuating every N±M lugs, where M is a positive integer.

12. The machine according to claim 7, further including a sensor for sensing the lugs in the non-actuated condition and generating an output signal, and a controller for controlling the motor based on the output signal of the sensor.

13. The machine according to claim 1, further including:
a second conveyor for conveying a plurality of second lugs selectively movable from a non-actuated condition to an actuated condition for engaging the carton, with adjacent second lugs in at least the non-actuated condition being spaced apart a distance in the conveying direction less than the length of a single carton in the conveying direction; and
a second actuator for actuating a first one of the second lugs for engaging the first carton.

14. In a conveyor for conveying partially formed cartons in need of conveyance using a plurality of lugs conveyed along a support surface for the cartons and capable of actuation to define a flight pitch of the actuated lugs for receiving at least one carton for conveyance, the improvement comprising an endless chain for carrying the lugs and having a length which is not an integer multiple of the flight pitch.

15. A machine for conveying a plurality of partially folded and formed cartons along a conveying path in a conveying direction, each carton having a length in the conveying direction between a leading and a trailing end, comprising:
a conveyor for conveying a plurality of lugs selectively movable from a non-actuated condition to an actuated condition for engaging the trailing end of the carton and conveying cartons along the conveying path in the conveying direction, with adjacent lugs in at least the non-actuated condition being spaced apart a distance in the conveying direction less than the length of a single carton in the conveying direction; and
an actuator for actuating every N lugs, where N is a positive integer greater than one.

16. The machine according to claim 15, wherein the actuator comprises a single diverter for engaging every N lugs in a sequential fashion.

17. A machine for conveying a partially folded and formed carton having an end along a conveying path in a conveying direction, comprising:
a conveyor for conveying a plurality of lugs arranged in tandem and selectively movable from a non-actuated condition to an actuated condition for engaging the end of the carton and conveying the carton along the conveying path in the conveying direction;
a controller for determining the passing of at least two first lugs in a non-actuated condition during conveyance and generating an output signal; and
an actuator for selectively actuating a second lug following the at least two first lugs based on the output signal from the controller.

18. A method for conveying a partially folded and formed carton having an end along a conveying path in a conveying direction, comprising:
conveying a plurality of lugs selectively movable from a non-actuated condition to an actuated condition for engaging the end of the carton and conveying the carton along the conveying path in the conveying direction;
determining the passing of a predetermined number of lugs relative to an actuator and generating a signal; and
actuating a selected lug based on the signal.

19. The method of claim 18, wherein the determining step comprises counting each lug in the non-actuated condition.

20. The method of claim 18, wherein the determining step comprises determining a position of a motor for conveying the lugs.

21. A method for conveying a plurality of partially folded and formed cartons along a conveying path in a conveying direction, comprising:
conveying an endless chain carrying a plurality of lugs selectively movable from a non-actuated condition to an actuated condition for engaging the carton and conveying the carton along the conveying path in the conveying direction at a first speed;
actuating a plurality of the lugs in a first, alternating sequence, each lug in the actuated condition conveying one of the cartons with the endless chain conveyed at substantially the first speed; and
actuating a plurality of the lugs in a second, alternating sequence different from the first alternating sequence, each lug in the actuated condition conveying one of the cartons with the endless chain conveyed at substantially the first speed.

22. The method of claim 21, wherein the first alternating sequence comprises actuating every N lug, wherein N is a positive integer greater than two, and the second alternating sequence comprises actuating every N±M lugs, where M is a positive integer.

23. A method for feeding cartons, comprising:
providing a plurality of partially folded and formed first cartons for conveyance along a conveying path, said first cartons each having a first dimension in a conveying direction;
conveying an endless chain carrying a plurality of lugs selectively movable from a non-actuated condition to an actuated condition for engaging the first cartons and conveying the first cartons along the conveying path in the conveying direction at a first speed;
sequentially actuating a plurality of the lugs while conveying the chain at the first speed, each lug in the actuated condition conveying one of the first cartons;
providing a plurality of partially folded and formed second cartons for conveyance along a conveying path, said second cartons having a second dimension in the conveying direction different from the first dimension;
actuating a plurality of the lugs while conveying the chain at the first speed, each lug in the actuated condition conveying one of the second cartons.

24. A method for feeding cartons, comprising:
providing a plurality of partially folded and formed first cartons for conveyance along a conveying path having a first dimension in a conveying direction;
conveying an endless chain at a first linear speed, said chain carrying a plurality of lugs selectively movable from a non-actuated condition to an actuated condition for engaging the first cartons and conveying the first cartons along the conveying path in the conveying direction;
sequentially actuating a plurality of the lugs, each lug in the actuated condition conveying one of the first cartons;
providing a plurality of partially folded and formed second cartons for conveyance along a conveying path having a second dimension in a conveying direction;
actuating a plurality of the lugs, each lug in the actuated condition conveying one of the second cartons, and conveying the chain with the actuated lugs at substantially the first speed to convey the second cartons.

25. The method of claim 24, further including the step of folding an open lid on one or more of the partially folded and formed first cartons.
